(19) United States
(12) Patent Application Publication
(10) Pub. No.: US 2012/0185905 A1
(43) Pub. Date: Jul. 19, 2012

(54) Content Overlay System

(76) Inventor: Christopher Lee Kelley, Sacramento, CA (US)

(21) Appl. No.: 13/006,155

(22) Filed: Jan. 13, 2011

(51) Int. Cl. H04N 9/74; H04N 7/173

(52) U.S. Cl. 725/109; 348/586; 348/E09.055

(57) ABSTRACT

A system for associating overlay content with video programming and for allowing viewers of video programming to view the associated overlay content during playback of the video program, and methods for operation of video equipment, associated display devices and network servers to provide overlay content are disclosed. The overlay content is associated with specific passages of the video program while the content itself may be asynchronous or synchronized to the frames of the video programming. Users are able to identify what content is available and to determine how it will be played and on what devices.

### BACKGROUND OF THE INVENTION

The introduction of digital high definition television signals (HDTV) and television monitors that are designed to display digital video signals based on interfaces such as Digital Visual Interface (DVI) and High-Definition Multimedia Interface (HDMI) is increasingly eliminating the barriers between the role of the home computer and the television. Computers equipped with DVD or Blu-ray drives can be used to watch high quality video and computer users can download encoded video from the internet and use software codecs implemented on their computer to decode and play this video.

It has become common for users to configure personal computers as home theater PCs (HTPCs) and to use these computers to serve as a digital video recorder (DVR) that can be used to record television programming and to play this programming back to a television monitor. These HTPCs can also be used to play digital video and audio retrieved from the internet in a variety of formats, to store and display photos and other fixed imagery and to browse the internet. An HTPC is an attractive device for viewing video or still images because it is connected to the television monitor, which is usually the largest and highest quality display in the house.

A number of devices have been introduced commercially that incorporate some of the capabilities of an HTPC in a compact form factor and come pre-bundled with applications for video playback, for internet browsing and for interacting with social networks. Examples of these products include Boxee, Google TV and Apple TV. See R. Hof, “Searching for the Future of Television,” Tech. Review, vol. 114, no. 1 (January/February 2011). These products are designed to provide plug and play HTPC-like capabilities without requiring users to acquire the various necessary multimedia software applications and to configure an HTPC to run these programs.

However, neither HTPCs nor the off-the-shelf HTPC-like solutions like Google TV fundamentally alter the experience of watching a TV program to make it into an interactive or social experience. Using these devices offers two essentially separate experiences. The TV monitor can be used to access internet content or to watch TV but the world of the internet does not intrude into the TV watching experience which remains unchanged from a traditional television. The HTPC may provide the decoding and/or playback function that drives the video programming, but the viewing experience is fundamentally similar to viewing broadcast TV on monitor without an HTPC.

What is needed is an apparatus and method that allows users to interact with televised programming in a way that can be shared. Users should be able to enrich the content of video programming by supplying supplementary text, graphics images, video and audio data, or what we will refer to generally as “overlay content,” that relates to the underlying program and be accessed by other viewers when they view that video program. In addition a method is needed for linking the overlay content to specific parts of a video program so that the content is presented to television viewers during the parts of the program for which it has relevance. A method is needed for tracking the playback of video programs and coordinating presentation of available overlay content based on the current playback position of these video programs. Finally, equipment is needed that can perform these various functions, including identifying relevant overlay content to viewers and allowing users to select and display that content.

### BRIEF SUMMARY OF THE INVENTION

An overlay content system is described according to the invention of this patent that identifies the program being played on a television monitor and determines if there is associated overlay content available. Without requiring user intervention, the overlay content system downloads content associated with the viewed program. The overlay content may be associated with specific playback passages within the video program. When there is overlay content relevant to the portion of the program currently being played back the system can identify this with visual or audio cues.

The overlay content may be identified by an associated icon or image and may be accompanied by descriptive text or audio. The invented overlay content system can identify to the user the available overlay content by presenting this summary information on the television monitor or on other display devices associated with the overlay content system.

If the user wishes to play any of the overlay content, they may select this content and the overlay content system can play it on the television monitor or one of the other playback devices associated with the system. The user can interact with the overlay content system using selection and pointing devices to interact with the display on the TV monitor, or they can use another device associated with the overlay content system, such as a wireless tablet or a cellphone to review available overlay content and to instruct the overlay content system as to what overlay content should be presented.

The overlay content may be asynchronous or synchronous. Asynchronous content, while it might be identified as having relevance to a particular part of a video program, is not synchronized on a frame-by-frame basis with the program. Playback of synchronous content, in contrast, is coordinated with playback of the program. The invented overlay content system may handle one or both of these types of overlay content.

The overlay content system allows the user to select whether overlay content will be presented on the television monitor or on another display device associated with the overlay content system. The user can also configure how the overlay content is presented. For example, the user may elect to suspend playback of the program while the overlay content is reviewed, or to review the overlay content in one portion of the monitor while the underlying program proceeds in the other. When appropriate, the user may be able to save overlay content for access on their computer network.

The present invention includes a set-top box that may implement features of the overlay content system in a home theater environment. The set-top box includes a processor for interacting with external servers accessed via the Internet and for communicating with display devices other than the traditional TV monitor that may be used to display or select overlay content. The set-top box also includes codecs and virtual machine used to generate overlay content locally for display on the TV monitor.

The overlay content system includes the ability to identify programming and to track playback locations within the programming based on identifying feature vectors from the video frames of the program. The feature vectors can be used to identify key frames and other intermediate frames. The feature vectors of these comparison frames and the deltas or number of frames that separate these comparison frames, can be compared by the overlay content system against reference indexes of feature vectors and deltas. The reference indexes allow the overlay content system to identify a program and to track playback progress through the program. Additionally, a reference index can be used to associate overlay content with specific passages in the video program. The set top box for the overlay content system includes a video controller that can perform analysis of a video stream and generate the feature vectors and frame deltas that may be used for tracking a video program played on the TV monitor.

The invented overlay content system includes features designed to address the fact that television programming is regularly interrupted by commercials and that different commercials may be presented to viewers in different locations and at different times even when the underlying program remains unchanged. The invented overlay content system allows the same overlay content to be presented regardless of variations in commercials. The overlay content system is also able to present overlay content during broadcast of live programming.

### BRIEF DESCRIPTION OF THE DRAWINGS

The features and advantages of the present invention will become more apparent from the detailed description set forth below, which refers extensively to the drawings and should be read in conjunction with those drawings.

FIG. 1 is a depiction of home theater equipment including a set-top box that incorporates overlay content system equipment in one embodiment of the invention in which the overlay content system is not tightly integrated with any tuner/DVR equipment.

FIG. 2 is a depiction of a television monitor display in one example embodiment of the invented overlay content system during playback of a video program, where the monitor displays an icon indicating that relevant overlay content has been identified.

FIG. 3A is a depiction of a television monitor display during playback of televised programming in an example embodiment of the invented overlay content system where the display incorporates icons identifying relevant available overlay content.

FIG. 3B is a depiction of the display of a wireless device in an example embodiment of the invented overlay content system where the wireless device is used to identify relevant available overlay content.

FIG. 3C is a depiction of the display of a wireless device in an example embodiment of the invented overlay content system where the wireless device is used to select overlay content to display and the manner of display.

FIG. 4 is a depiction of a television monitor display during playback of programming in an example embodiment of the invented overlay content system where the monitor is used to identify relevant available overlay content.

FIG. 5 is a depiction of a television monitor display during playback of programming in an example embodiment of the invented overlay content system where the monitor is used to simultaneously display both the primary program and overlay video and image content synchronized to the program.

FIG. 6 is a depiction of the functional elements of a set-top box in accordance with one embodiment of the invention that implements both tuner/DVR functions and overlay content system functions.

FIG. 7 is a depiction of the network elements used in one embodiment of the invented overlay content system to provide program tracking information and overlay content.

FIG. 8 is an illustration of the format of a frame index object and frame index identifier in accordance with one embodiment of the invention.

FIG. 9A is an illustration of the format of the data for an overlay content reference in accordance with one embodiment of the invention.

FIG. 9B is an illustration of the format of a comparison frame index in accordance with one embodiment of the invention in which the comparison frame index includes provision for identifying commercial gaps in programming.

FIG. 10A is an illustration of the relationship, according to one embodiment of the invention, between blocks of synchronous overlay video and the frames of the primary program.

FIG. 10B is an illustration of the format of an overlay content data structure for use with synchronous overlay content in accordance with one embodiment of the invention;

FIG. 11A is a flowchart illustrating the process for tracking the playback of a video program in accordance with one embodiment of the invention.

FIG. 11B is a pair of flowcharts illustrating the processes for determining whether overlay content is relevant to the current playback position of a program and for identifying relevant content to the user and removing the content from display after the playback position has advanced to a point where content is no longer relevant.

FIG. 12 is a depiction of the relationship between feature vectors derived from program frames and the frame identifiers in a comparison frame index according to one embodiment of the invention.

### DETAILED DESCRIPTION OF THE PREFERRED EMBODIMENTS

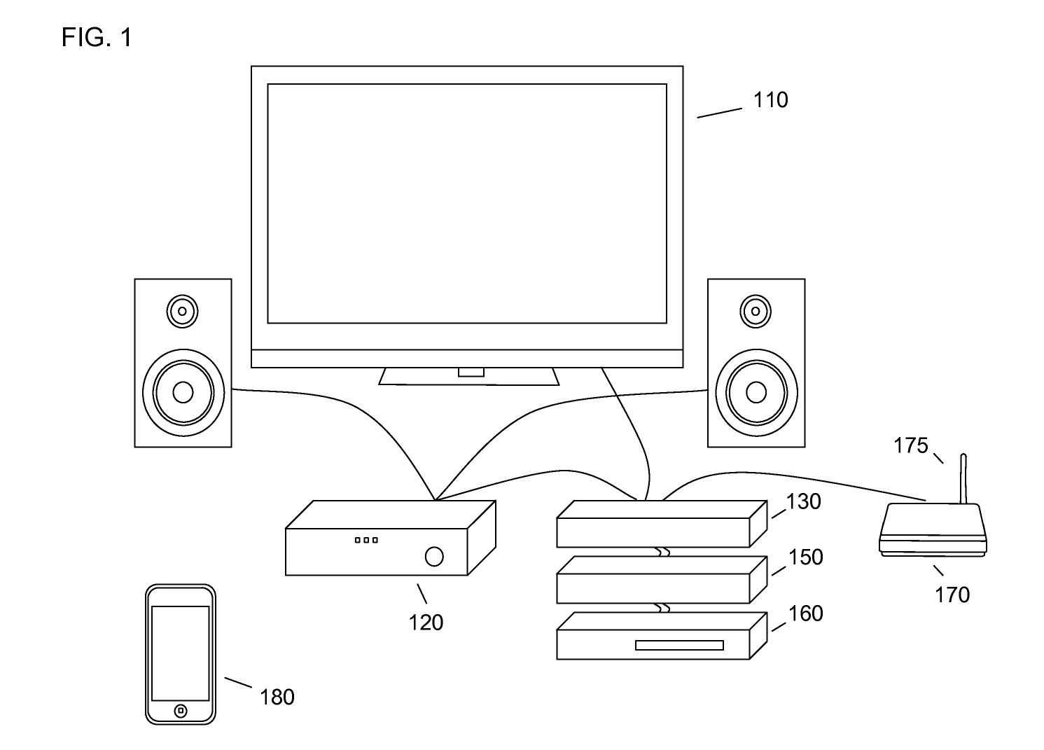

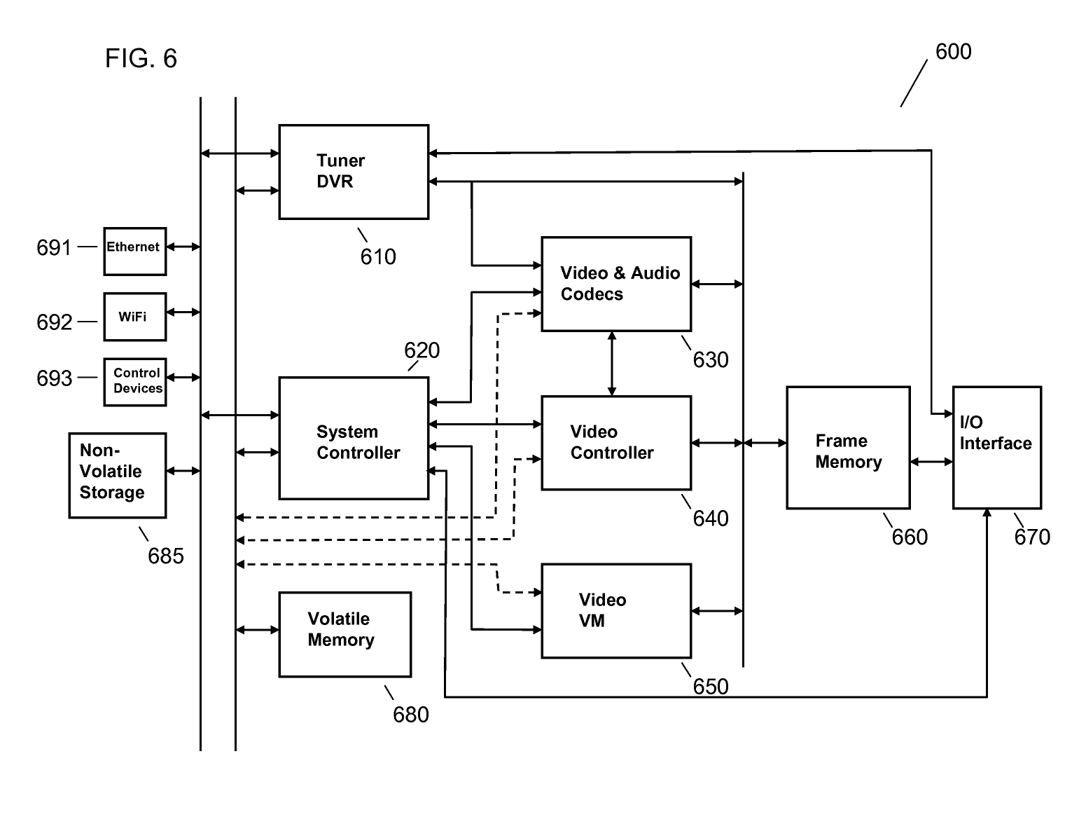

An entertainment system and local area network integrating one embodiment of the overlay content system is illustrated in FIG. 1. In this configuration, the invented overlay content system is contained in a stand-alone set-top box 130. It is connected to several video content sources including a television signal decoder/tuner and digital video recorder (DVR) 150 and a DVD or Blu-Ray disk player 160. The set-top box 130 can be connected to these sources of programming using, for example, HDMI cable connections and/or legacy video connections, such as composite and component video. While the decoder/DVR 150 and disk player 160 are packaged separately from the overlay system in FIG. 1 and, therefore, communicate with it only through standard cabling interfaces, in an alternative configuration it is also possible to integrate the overlay content system with content source hardware, such as decoder/DVR 150. An integrated system of this sort is described later in connection with FIG. 6.

Continuing with FIG. 1, the set-top box 130 is connected to a TV monitor 110 and audio receiver or amplifier 120, which drives a speaker system. Set-top box 130 provides video output signals to monitor 110 through standard cabling formats such as HDMI, composite and component video. It also provides independent audio output signals for audio systems such as amplifier 120 in standard interface formats such as digital optical audio, digital coax and RCA jacks.

The set-top box 130 may include its own wireless radio for communicating with wireless devices or connecting across a wireless connection to a local area network. Set-top box 130 also may incorporate a network connection, such as an Ethernet network jack to allow it to be connected to a wired local area network (LAN). In FIG. 1 the set-top box 130 has access to the internet through network switch 170 and may also access wireless radio 175 in order to communicate with other devices connected to the LAN through a wireless connection.

Users of the overlay content system shown in FIG. 1 may access the control functions of set-top box 130 from one or more wireless devices 180. Wireless device 180 can take a variety of forms including, for example, a mobile phone or a tablet computer. In addition to being used as a control device for controlling the operation of set-top box 130, wireless device 180 can also be used to display overlay content associated with the primary programming being presented on TV monitor 110. Wireless device 180 may communicate with the set-top box 130 through a wireless LAN either by way of wireless radio 175 or a wireless access point incorporated into set-top box 130. Alternatively, if the wireless device 180 is a mobile phone or mobile data device it may communicate with set-top box 130 by way of a wireless wide area (WAN) network data service, such as the current 3G and 4G voice and data networks or their successors. When the wireless device 180 communicates with set-top box 130 by way of a wide area network (WAN) it must transmit communications destined for set-top box 130 to the WAN, through the internet or other public network, to the gateway device connecting the user's local area network to the internet, through the switch 170 and finally to the set-top box 130.

### Overlay Content Presentation

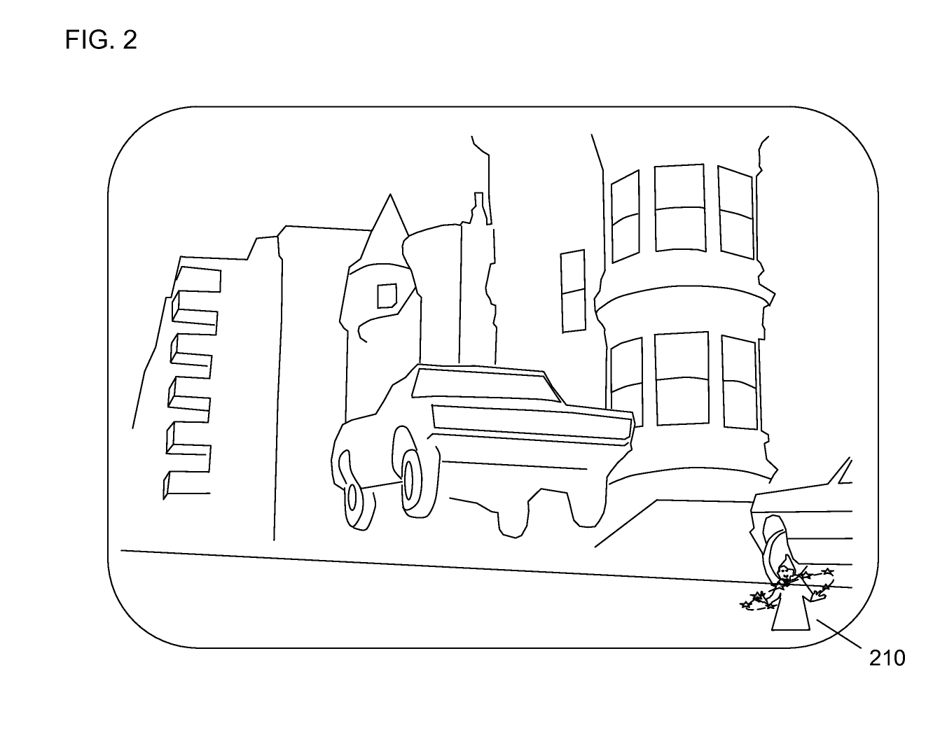

FIG. 2 provides an example of how one embodiment of the content overlay system might provide visual notification to a user that overlay content relevant to the current program on monitor 110 is available. In this embodiment, an icon 210 is displayed at the bottom of monitor 110 when overlay content is available. In order to minimize the level of intrusion, the icon is presented in a corner of the display and is made partially transparent. Icon 210 can be generic to the overlay content system or it can be changed to provide information about the nature of the overlay content or types of overlay content that are available.

Overlay content is typically cued to a particular playback window within a program. The originator of the overlay content may identify the content as being relevant to a particular window of time during the program. We will refer to this playback period as the “play window” for the overlay content. In one embodiment the overlay content system displays an appropriate overlay icon at the beginning of any time window during the program when there is overlay content available. The overlay content system can be configured to display the icon continuously or only periodically for short intervals when overlay content is available. Alternatively, the notification can take the form of a short sound or chime played over the audio system without any corresponding visual cue.

If the user is interested in reviewing what overlay content is available, they can indicate a request to view an enumeration of available content using an input device connected to set-top box 130 or by way of a control application on wireless device 180. When an alternate display device, such as wireless device 180, is available and able to communicate with the overlay system, the user may indicate whether they prefer to see the available overlay content identified on monitor 110 or on the display of wireless device 180. Displaying overly content options on a separate wireless device 180 has the advantage that it does not interfere with playback of the primary programming on the monitor 110. Mobile devices built on the Android, Windows Phone 7 or the iPhone iOS include notification services that allow applications on those phones to provide notifications to their users. Mobile device applications designed for use with the overlay content system can be deployed on these phones to provide notification using these notification services to mobile device users when there is content relevant to the current playback position of the video program that is available for retrieval and presentation.

In one embodiment, if the user selects monitor 110 as the mechanism for displaying available overlay content options, the available overlay content is displayed on the bottom of monitor 110 while the primary programming continues. Alternatively the user may specify that the current primary program is to be suspended while the available overlay content is identified on monitor 110.

In another embodiment, the overlay content system can also be configured so that it does not provide any visual indications of the presence of overlay content until the user takes some affirmative step to prompt the presentation of the various types of overlay content available. This affirmative step may include using an input or pointing device attached to set-top box 130 or an application on wireless device 180 to indicate that available overlay content should be enumerated.

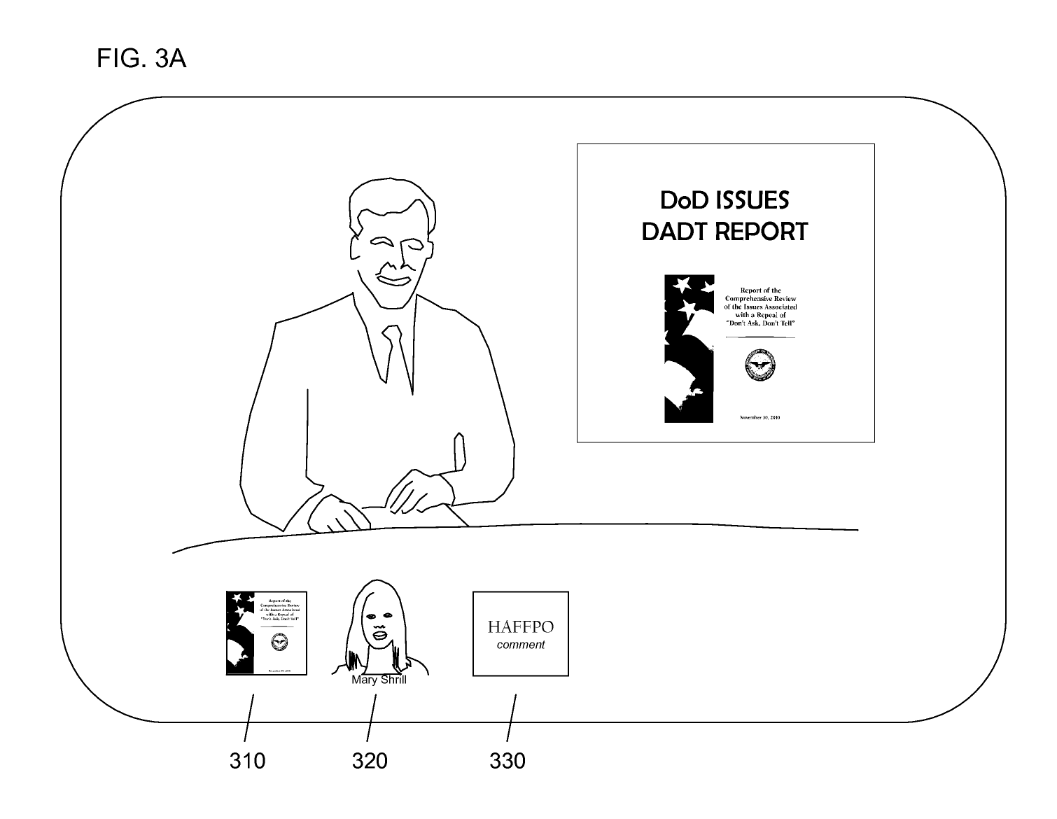

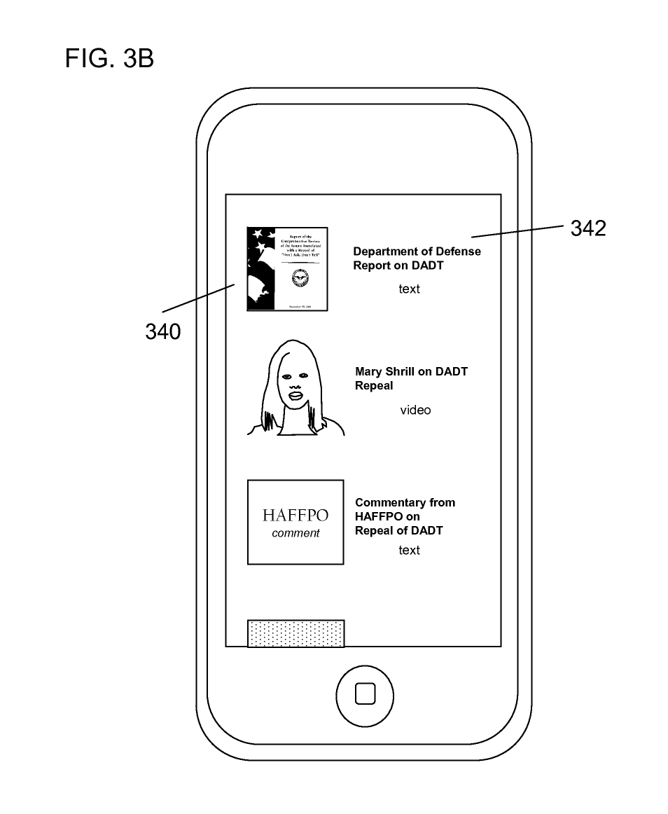

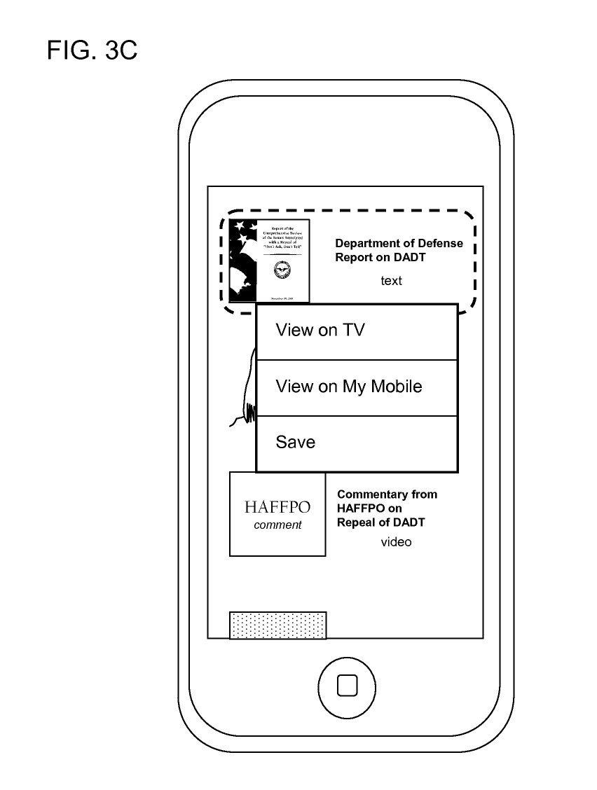

FIG. 3A illustrates an example of how specific overlay content might be identified on monitor 110 during a news broadcast in one embodiment of the overlay content system. The system has been configured to display overlay content icons on the lower portion of the screen. In the example shown in FIG. 3A the news story concerns a report prepared by the U.S. Department of Defense. The network originating the news broadcast has made a copy of the report available as overlay content for downloading. A first icon 310 based on the cover of the report is displayed in the lower left hand corner of the monitor. In this example, if the user selects this content by selecting icon 310, the overlay content system could download the report in a portable format such as the well known PDF format for display on monitor 110. Alternatively the content can be downloaded by the content overlay system and displayed on an associated display device such as wireless device 180. To the right of first icon 310 is second icon 320 that is a “headshot” of a well-known internet commentator. In this example, this commentator has associated their commentary on the Defense Department report with this news broadcast. Selecting second icon 320 will lead to presentation of the commentary. Third icon 330 is an image associated with an internet website that also has commentary on the Defense Department report. The user of the content overlay system can access this commentary by selecting icon 330. The commentary is in the form of written text and when the user selects it they have the option to have the text appear on monitor 110 or, if the user desires, on wireless device 180.

FIG. 3B is an illustration of the appearance of a display enumerating available overlay content on a wireless device 180 associated with the overlay content system in one embodiment of the invention. Because this list of relevant overlay content does not occupy portions of the monitor 110 and threaten to obscure part of the primary programming it may include additional information about the available overlay content. In the display illustrated in FIG. 3B the information displayed for each overlay content option includes an icon 340 and descriptive text 342 that includes a title and a description of the nature of the overlay content (whether it is text, video, audio, etc.). The display could also provide information such as an indication of the source of the content, community ratings of the content, duration of the content if it is audio or video, an indication of whether the content is asynchronous or synchronous, and other data that may be of interest to users. In one embodiment of the system, users can configure the system by selecting the type of information about overlay content that should be displayed when available content is enumerated. If the number of available overlay content items is too large to fit in on the display, the display can be made scrollable, so that the user can scroll through the entire listing.

If the user elects to play or download some piece of overlay content they can indicate this by “clicking” on or otherwise selecting the content from a list of icons identifying available content. When the overlay content is enumerated on a wireless device 180 the user may do this using a touch-sensitive display. When the overlay content is enumerated on monitor 110, the user may use a remote control or other input device to select an overlay content icon. When the user selects overlay content they may be queried as to how the overlay content is to presented. FIG. 3C is an illustration of a display on a wireless device 180 associated with the overlay content item in one embodiment of the invention. The set-top box 130 communicates the available display options for any overlay content selected by the user to wireless device 180 so that these options may be presented to the user. In the particular example shown in FIG. 3C the selected overlay content is text in a portable format, such as a PDF file. In one embodiment of the invention the user may elect to display this content directly on the TV monitor 110, to display it on wireless device 180 or to download it for storage on the set-top box 130 where it can be accessed by other network devices. These options are presented in the pop-up meno shown in FIG. 3C. In one embodiment of the invention users may configure the overlay content system so that downloaded content is automatically transferred to network devices resident on a LAN to which the set-top box 130 is connected, such as a network attached storage (NAS) device or a computer.

In FIG. 3C the application on wireless device 180 has been designed to present the available display options to the user for selection after the user has selected a particular piece of overlay content. After selecting one of the available presentation options shown in FIG. 3C the user might be asked to make additional selections about where the content will be displayed. For example, if the user elected to display the text document on monitor 110, they might also be permitted to further select between suspending playback of the primary program while they reviewed the document on the monitor, to present the document in a window on the monitor 110 overlayed over the program or to divide the available space on the monitor in a “split screen” configuration so that one of portion of the monitor was used to carry the video program while the other was used to review the overlay content.

In other embodiments, the user might be able to specify a default action for particular types of content. The content overlay system would display the overlay content in accordance with the default action unless the user took additional actions at the time they requested the overlay content to indicate that they wished to select a non-default display technique.

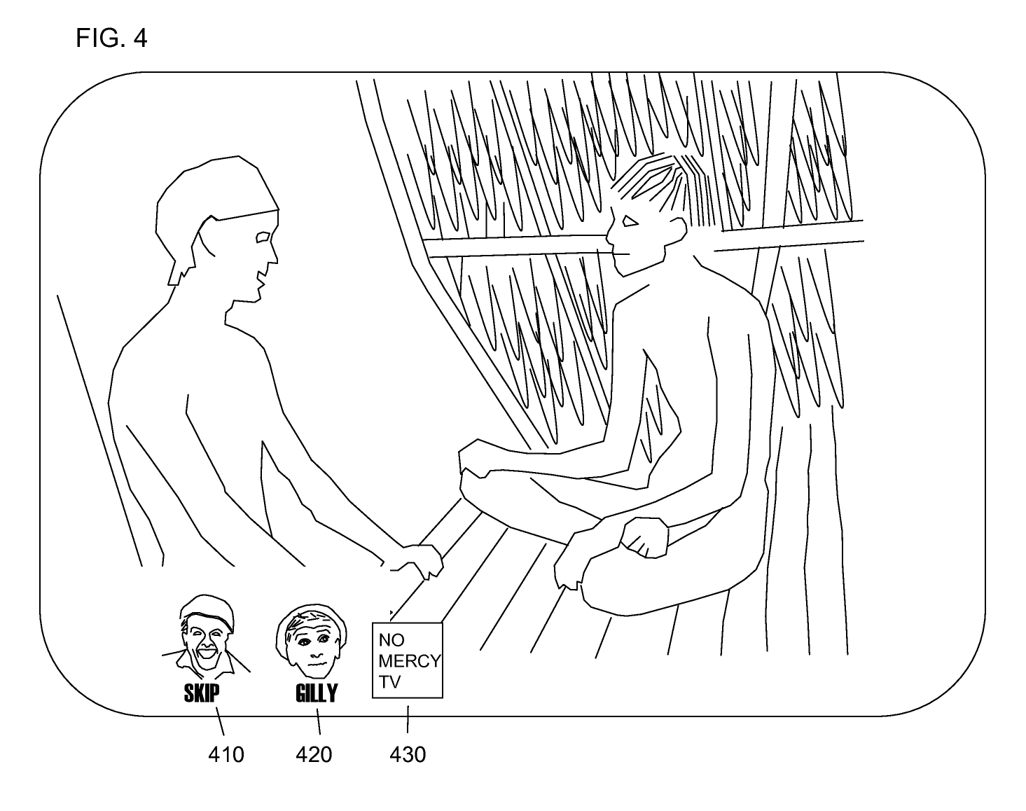

FIG. 4 illustrates the appearance of monitor 110 in one embodiment of the content overlay system during an example reality television show about island castaways. The user has asked the overlay system to display available overlay content icons, and in this embodiment the user has configured the overlay content system to display overlay content icons on the bottom of monitor 110. The broadcast network originating the reality show has provided overlay content that supplements the main narrative thread carried by the primary programming. While the primary programming in this example contains a scene of two of the castaways plotting together in private, other overlay content is accessible through icons 410 and 420, each an image of other castaway characters not presently on screen in the primary programming. If the overlay content system user selects one of icons 410 or 420 in this example they can access overlay content consisting of video segments revealing the actions of the character in the selected icon at times contemporaneous with the action presented in the primary programming.

A third icon 430 is also presented. Icon 430 corresponds to voice-over commentary on the action from an internet website that regularly provides humorous commentary on this television show. Unlike the other overlay content examples in FIGS. 3 and 4, the voice-over audio is intended to be played back synchronously with the primary program. If the user selects this icon the overlay content system adds the voice-over commentary to the audio track for the program deployed with the primary audio through amplifier 120. The overlay content system coordinates playback of the audio with the underlying programming so that the commentary is synchronized to the action of the program. Alternatively, the content overlay system can be configured to direct the voice-over audio to an associated device such as wireless device 180.

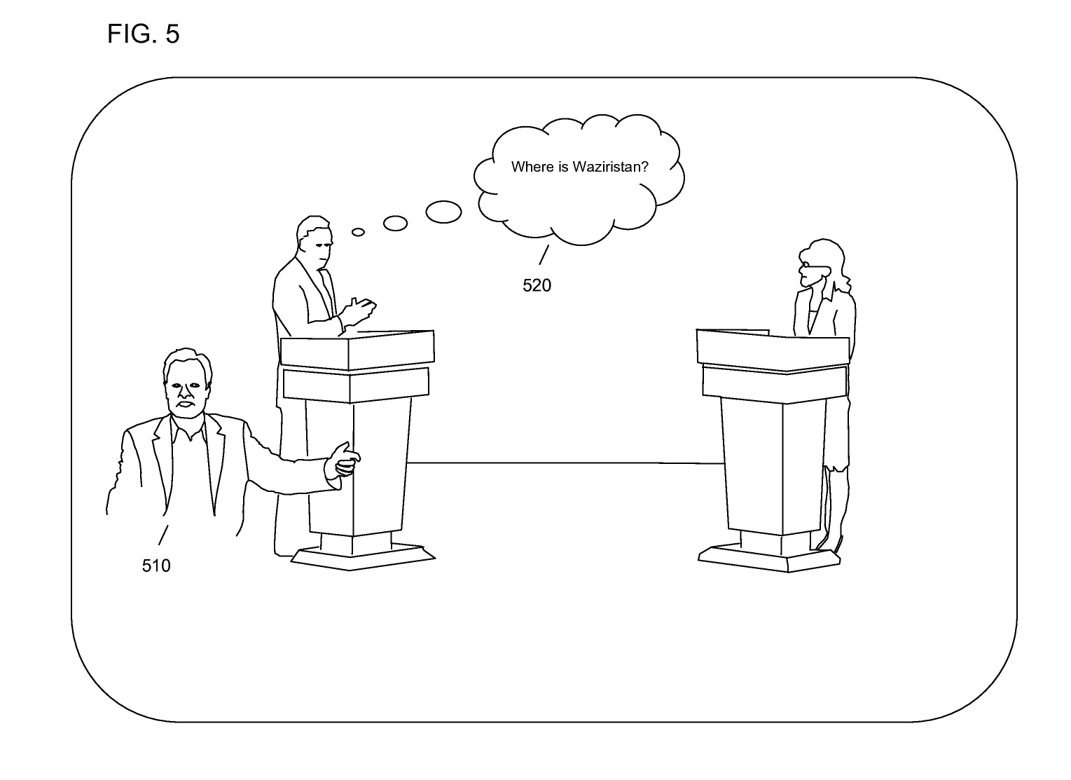

FIG. 5 illustrates the appearance of monitor 110 in one embodiment of the invention where synchronous overlay content is displayed with an underlying program. In this example the primary program is video from a debate between two candidates for political office. In this example the user has elected to display two pieces of synchronous overlay content. The first overlay 510 is a video sample of a television personality offering commentary on the debate. The video is synchronized to the debate footage so that the video commentary of the television personality reacts to the actions and speech of the debaters.

The overlay video 510 can be provided in several formats. In one format the video occupies a rectangle of fixed dimension. The user of the overlay content system can specify how large a region of the monitor 110 this rectangle is to occupy and where on the monitor it should be placed.

In another format, the overlay video is shot with a chroma key or “greenscreen” backdrop. When the video overlay content is selected the set-top box overlays only those portions of the video that do not contain the color used in the chroma keying. Chroma keying or “greenscreening” techniques are well known to persons of ordinary skill in the art. See S. Wright, Digital Compositing for Film and Video, (2^{nd} Ed. 2006). The user of the overlay content system may scale the size of the overlay video and specify its location on monitor 110. In FIG. 5, first overlay content 510 is shown as it would appear if it were “greenscreen” content.

The second overlay 520 is static imagery, in this case a thought bubble cartoon, overlayed over the video. The appearance and disappearance of the thought bubble is synchronized to the primary program although the thought bubble image itself is static. Second overlay content 520 may be supplied in the form of a image bitmap, or it may be defined by virtual machine instructions, or bytecodes, that when executed by the set-top box 130 cause it to draw the desired overlay content on a particular portion of the imaged displayed on monitor 110. A piece of overlay content may consist of a sequence of multiple such static overlays or a sequence of both dynamic and static content.

### Overlay Content System Organization

FIG. 6 is a diagram of the arrangement of major functional blocks in one embodiment of the overlay content system where the overlay content functionality has been included in an integrated set-top box 600 that also includes TV tuner and DVR function 610.

The set-top box 600 includes a tuner/DVR block 610, and a system controller block 620. Tuner/DVR function 610 and system controller 620 are also connected to a volatile memory 680 and also to support functions including a wired network interface 691, such as a wired Ethernet port, a wireless network interface 692, an interface for input/output control devices 693, such as a USB port, and a non-volatile storage device 685, such as a disk drive or flash memory.

The set-top box 600 also includes a collection of video and audio codecs 630, a video controller function 640 and a virtual machine (VM) function 650. These functions can be implemented as software functions on one or more CPUs or digital signal processors (DSPs), as dedicated circuit elements, or as a combination of both dedicated hardware and software. While the functions are illustrated as separate blocks in FIG. 6 this is for ease of explanation and is not intended to indicate any particular implementation of these functions. In one embodiment of the invention these three functions could be implemented in a single processor.

The tuner/DVR function 610, the video and audio codecs 630, the video controller 640, and the VM 650 are all connected to video frame memory 660, which stores frames of video and audio data. While frame memory 660 is illustrated as separate from volatile memory 680, in one embodiment they may be integrated into a single memory.

I/O interface 670 generates video and audio output signals for set-top box 600. These output signals can be supplied in analog or digital formats. For example, the I/O interface 670 may provide video and audio signals in a standard digital format such as HDMI. The I/O interface 670 can receive video and audio signals from tuner/DVR function 610, can access frame memory 660 to retrieve frame data for transmission as a video output signal and audio data for generation of audio outputs. I/O interface 670 also has a control signal interface with system controller 620 for exchanging control information. In addition, I/O interface 670 may also be able to receive video and audio signals from “upstream” devices connected to signal interfaces supported by the I/O interface 670, such as disk player 160. The I/O interface 670 can be configured by system controller 620 to store incoming video and audio signals received from another device in frame memory 660. From the frame memory 660 these signals may be analyzed by video controller 640, and video and/or audio content can be overlayed on the video frames and audio data by video controller 640 or VM 650. The modified video frames and audio data can then be transmitted over I/O interface 670.

The system controller 620 implements the various control functions required for operation of both the DVR and the overlay content system.

The video and audio codecs 630 implement codecs for encoding and decoding video and audio content. The codecs 630 can be used for traditional DVR operation and for content overlay system operation. In traditional DVR operation, the codecs can be used for encoding received video programming for long-term storage in non-volatile storage 685, and for later decoding stored data for playback. When the codecs 630 are used for encoding data they typically retrieve a block of frame data from volatile memory 680, encode it and write it back to another region of the volatile memory 680. The encoded data can then be transferred by the system controller 620 to non-volatile storage 685.

When the codecs are used for decoding audio or video content they typically retrieve blocks of encoded data from volatile memory 680, decode the data block to form audio and/or video frames and then transfer the resulting decoded playback data either to frame memory 660 or back into volatile memory 680.

Frame memory 660 is used to store video and audio data that is to be outputted from the set-top box 600 for playback in the near future. Video and audio data is stored here in a format in which it can be quickly converted by I/O interface 670 for transmission on audio and/or video outputs.

I/O interface 670 is connected to, and can retrieve data from, frame memory 660. I/O interface 670 converts stored video frames into analog signals for output as composite or component video signals, or reformats the frame data for transmission on a digital interface such as HDMI.

The operation of the I/O interface 670 is controlled by system controller 620 through a control signal connection. System controller 620 specifies parameters for I/O interface 670 such as what output interfaces are to be driven, the frame rates and resolutoins for video outputs and master volume levels for the audio outputs. In addition the system controller 620 may also specify values for various other parameters carried by a digital signal interface such as HDMI.

In addition, I/O interface 670 may also receive “upstream” control signaling across a digital interface from other devices connected by external signals to the I/O interface 670, such as monitor 110. HDMI, for example, includes a Consumer Electronics Control (CEC) link that allows one HDMI device to pass configuration and control information to other HDMI devices. When I/O interface 670 receives CEC communications from another device across one of its HDMI interfaces, the content of these communications is provided to system controller 620 for processing. Likewise, any outgoing CEC communication is generated by system controller 620 and conveyed to I/O interface 670 for transmission across the appropriate HDMI link.

Video and audio signals may be received and transmitted in an encrypted format. HDMI cabling, for example, can be used to carry encrypted data. I/O interface 670 may include the ability to encrypt audio and video information to be transmitted and to decrypt received audio and video signals in accordance with the requirements of relevant signal transmission standards. System controller 620 may provide relevant control information for the encryption and decryption process.

Virtual machine (VM) 650 provides one mechanism by which set-top box 600 can generate video and audio overlay content for display on monitor 110. As is familiar to persons of ordinary skill in the art, a VM implements a target set of instructions or functions. Programmers can write code for the traget instruction set of the VM without concerning themselves about the particular manner in which those target instructions will be implemented on specific processing hardware. The virtual machine defined for use with the Java programming language is widely used in cross-platform applications such as in mobile phones. The instruction set of a general purpose VM can be supplemented with libraries for audio and 2-D and 3-D graphics generation. This approach is used in Google's Android system for mobile phones where a general purpose VM is supplemented with libraries for graphics and database operations.

In one embodiment of the invention, VM 650 may include support both for a general purpose target instruction set like Java as well as supplemental libraries particularly suited for graphics and audio applications. The virtual machine can be designed to implement an existing target instruction set, such as the bytecodes used in Java. Alternatively, or as a supplement, VM 650 can be designed for a target instruction set that is designed specifically to support graphics and video overlay applications.

In one embodiment, the set-top box 600 can generate overlay content by several techniques. The overlay content may be received in a data format such as encoded video or audio. Encoded video, for example, can be decoded by codecs 630 and written to frame memory 660 for display. Alternatively, the overlay content may be received not as data alone, but as a program targeted for execution by VM 650 or its associated libraries. When the program is executed by VM 650 it generates the desired overlay content when the program includes instructions or library calls that cause the VM 650 to generate video and/or audio overlay data which is then written to frame memory 660 and transmitted to monitor 110 by I/O interface 670.

Another way for the set-top box 600 to generate overlay content is to receive overlay content in a data format that is not processed by codecs 630. For example the overlay content may consist of text in a standard portable format such as a PDF file. In one embodiment, set-top box 600 may include viewers for specific types of content stored in non-volatile storage 685 and written in the target instructions and library function calls of the VM 650 and its associated libraries. When a particular type of content is received the set-top box 600 may cause an appropriate viewer to run on VM 650 in order to present this content. The viewer will generate video frame data displaying the content and write these to frame memory 660 from where they will be transmitted to monitor 110 by way of I/O interface 670.

Frame memory 660 stores data representing video frames in an uncompressed format. Frame memory 660 can be used to store frames that will be transmitted across I/O interface 670 for presentation on monitor 110. Frame memory 660 can be used to overlay multiple sources of image content into a single video frame. For example, video codecs 630 may generate underlying video frame data that is stored in frame memory 660. Video controller 640 and/or VM 650 may then add image elements to the video frame before it is transmitted over I/O interface 670. Video controller 640 may contain multiple pending video frames. Uncompressed audio samples can also be stored in frame memory 660 before transmission to monitor 110 or amplifier 120. Additional audio elements generated by video controller 640 or VM 650 can be added to the audio signals before they are transmitted over I/O interface 670.

Wired network interface 691 and wireless network interface 692 allow set-top box 600 to communicate with other devices on the LAN and the internet. The system controller 620 may access the internet to download programming schedules, to receive DVR programming commands remotely and to receive system configuration and upgrades. To perform its overlay content functions system controller 620 uses the internet to identify programs and to find available overlay content and retrieve it.

When overlay content is to be generated and displayed on an associated device, such as device 180 in FIG. 1, the system controller 620 may transfer the necessary overlay content data required for displaying the content from non-volatile storage 685 to the wireless device 180 by way of wireless network interface 692 or wired network 691 and the public WAN.

In FIG. 6 dashed lines show connections between codecs 630, video controller 640, VM 650 and volatile memory 680. It may be advantageous to provide these devices direct access to volatile memory 680 because this way they can obtain rapid access to the data in the memory requiring the involvement of system controller 620. The dashed lines indicate possible direct connections of this sort.

Control device connection 693 is used to allow user control devices to be connected directly to set-top box 600. These devices can include a mouse, trackball remote control or pointing device. In one embodiment, the control device connection 693 may be standard interface such as a universal serial bus (USB) port.

### Content Overlay System Functions

As illustrated in FIG. 6, DVR functions may advantageously be incorporated into a set-top box 600 with an overlay component system. The functions of a tuner/DVR are well known to persons of ordinary skill in the art and will not be discussed here, except to the extent that these functions interact with the operation of the overlay content system components of the set-top box 600.

The primary operations of the overlay content system are: identifying programming, tracking the playback position of a program, enumerating overlay content options when requested by users, and taking whatever action with regard to selected overlay content that a user may select, such as displaying the overlay content. These functions will be discussed below and the possible roles of the various functional blocks shown in FIG. 6 in performing these functions will be identified, when appropriate.

### Identification of Programming

There are several ways that the overlay content system can identify programming. If the program is being viewed live or originates from the DVR, the system controller 620 will normally have access to TV programming schedules in an electronic program guide (EPG) that may identify the title of the program, the network or channel on which it originates, start and stop times and duration, and may also provide a description of the program. As discussed below in greater detail, in one embodiment of the invention, the overlay content system may also determine the identity of a program by gathering feature vectors and other identifying data from the video frames or audio from the program and matching these to data records on a tracking server that contains data for a variety of video programs. If the characteristic information collected by the content overlay system in set-top box 600 matches any of the entries stored on the tracking server, the program can be identified as being the same program as the one that generated the characteristic data stored on the tracking server. The bibliographic data obtained from an EPG or other source can be used in conjunction with the feature vectors and other characteristic data to make a match.

In one embodiment of the invention, the overlay content system may use characteristic data from the program for program identification even if it also has access to identifying information for the program from an EPG. Sometimes an EPG may contain inaccuracies or may not correctly distinguish between different episodes of a recurring show. The characteristic data permits the tracking server to correctly identify the specific program.

In the technical literature on matching and retrieval of video sequences, a variety of techniques have been proposed for doing video image comparisons. One technique that is commonly used is to segment an image into different regions and to produce a histogram of the measured image properties, often the color planes (e.g. RGB and YUV color separations). See Schettini et al., “A Survey of Methods for Colour Image Indexing and Retrieval in Image Databases;” Gong et al., “Image Indexing and Retrieval Based on Color Histograms,” Multimedia Tools and Applications, vol. 2, pp. 133-156 (1996); Kashino et al, “A Quick Search Method for Audio and Video Signals Based on Histogram Pruning,” IEEE Trans. on Multimedia, vol. 5 no. 3 (September 2003). While three color planes can be used it is common to segment the image colors even further. For the purposes of this discussion we will refer to the YUV planes with the understanding that a larger number of color segments could be used. An alternative method of characterizing a video frame is to analyse the frame's spectral properties using discrete cosine transforms (DCT) or wavelet decomposition. See Naphade et al., “A novel scheme for fast and efficient video sequence matching using compact signatures,” Proc. of SPIE Conf. on Storage and Retrieval for Media Databases (January 2000) and Liu, “Image Indexing in the Embedded Wavelet Domain,” M.S. Thesis, Univ. of Alberta (2002). Other techniques involve extracting texture or shape information from the image. In “Robust Video Fingerprinting for Content-Based Video Identification,” IEEE Transactions on Circuits and Systems for Video Technology, vol. 18 no. 7 (July 2008), pp. 983-988, Lee & Yoo describe calculating the centroid of grayscale pixel gradients in the two dimensions of the video image and using this centroid of the various regions of the image as an identifying feature of the image.

One or several of these techniques can be used to derive features from video frames drawn from a program that the overlay content system is to identify. These features are collected into a feature vector that characterizes the frame and then the feature vectors from different frames can be compared to assess the similarity or divergence of two frames. The techniques will be familiar to persons of ordinary skill in the art.

The video matching required for the content overlay system need not be done on a frame-by-frame basis. For our purposes, it is sufficient to compare frames from the program that is to be viewed by the user against occasional frames drawn from the sources that are to be matched to the viewed video program. The concept of a key frame is used to identify frames to be compared. A key frame is a frame that is identified by its distinctive feature vector. Key frames are often selected on the basis of their divergence from previous frames so that they correspond to a scene or shot change in the video program. See, Costaces et al., “Video Shot Boundary Detection and Condensed Representation: A Review,” IEEE Signal Proc., vol. 23 no. 2 (March 2006); Kim & Park, “An Efficient Algorithm for Video Sequence Matching Using the Modified Hausdorff Distance and the Directed Divergence,” IEEE Trans. on Circuits and Systems for Video Technology, vol. 12 no. 7 (July 2002). In the content overlay system, key frames may be selected based on a measure of their divergence from the previous frame. Alternatively, key frames can be selected based on divergence from an average of window of previous frames or based on a cumulative divergence calculated as a sum of divergences over previous frames scaled by the time size of the window to avoid frame rate comparison problems.

There are many possible measures for frame divergence. Techniques for measuring the divergence of color histograms include the histogram intersection measure and the Euclidean and Quadratic distances between the two histograms. The Quadratic distance is measured by:

$${\sum }_{z} {( {F}_{1 , Y} ( z ) - {F}_{2 , Y} ( z ) )}^{2} + {( {F}_{1 , U} ( z ) - {F}_{2 , U} ( z ) )}^{2} + {( {F}_{1 , V} ( z ) - {F}_{2 , V} ( z ) )}^{2}$$

where F₁(z) and F₂(z) are the color values for the first and second frames to be compared, the subscripts Y, U and V denote the various color planes and z ranges across the various regions of the image. (As discussed above fewer or more than three planes may be used; the use of YUV here is merely an example.) The values F₁(z) and F₂(z) may constitute histograms of the color components of the region. The contributions of each color plane can be separately weighted if desired. The histogram intersection and Euclidean measures are described in Swain & Ballard, “Color Indexing,” Int'l J. of Computer Vision, vol. 7 no. 1 (1991); and Liu.

An alternative measure is the “directed divergence” measure used in Kim & Park which accumulates the divergences between the two frames across all regions of the frame and color planes. The directed divergence is given as:

$${\sum }_{z} {F}_{1 , Y} ( z ) log \frac{{F}_{1 , Y} ( z )}{{F}_{2 , Y} ( z )} + {\sum }_{z} {F}_{2 , Y} ( z ) log \frac{{F}_{2 , Y} ( z )}{{F}_{1 , Y} ( z )} + {\sum }_{z} {F}_{1 , U} ( z ) log \frac{{F}_{1 , U} ( z )}{{F}_{2 , U} ( z )} + {\sum }_{z} {F}_{2 , U} ( z ) log \frac{{F}_{2 , U} ( z )}{{F}_{1 , U} ( z )} + {\sum }_{z} {F}_{1 , V} ( z ) log \frac{{F}_{1 , V} ( z )}{{F}_{2 , V} ( z )} + {\sum }_{z} {F}_{2 , V} ( z ) log \frac{{F}_{2 , V} ( z )}{{F}_{1 , V} ( z )}$$

The passages from the references discussed above describing alternative techniques for calculating feature vectors (Liu §2.3, Lee & Yoo, §II, Schettini §§3 & 4, Swain & Ballard §2) and techniques for measuring video divergence or similarity (Liu §2.3, Kim & Park §II, Lee & Yoo §III and Swain & Ballard §3) as well as the description of shot boundary detection in §II of Cotsaces are incorporated herein by reference.

In one embodiment of the overlay content system, a comparison frame selection algorithm is used to identify the frames that will be compared between the program playing on set-top box 600 and a program reference. A frame characterization algorithm is then used to generate the feature vectors for the frame identified by the comparison frame selection algorithm so that the frames observed by the set-top box 600 can be compared against reference feature vectors calculated in the same manner from the frames of the program reference.

In one embodiment of the content overlay system, the comparison frame selection algorithm identifies key frames based on a divergence measure comparing a current frame against the preceding frame using color histograms. In an alternative embodiment, DCT or wavelet decomposition could be used to generate histograms. The key frames are identified by the fact that they have divergence measures that are above a threshold value.

If the key frames identified by the comparison frame selection algorithm are separated by more than a threshold distance in frames or time, the comparison frame selection algorithm may select additional intermediate frames based on their frame or time offset from the previous key frame so as to ensure a minimum density of comparison frames.

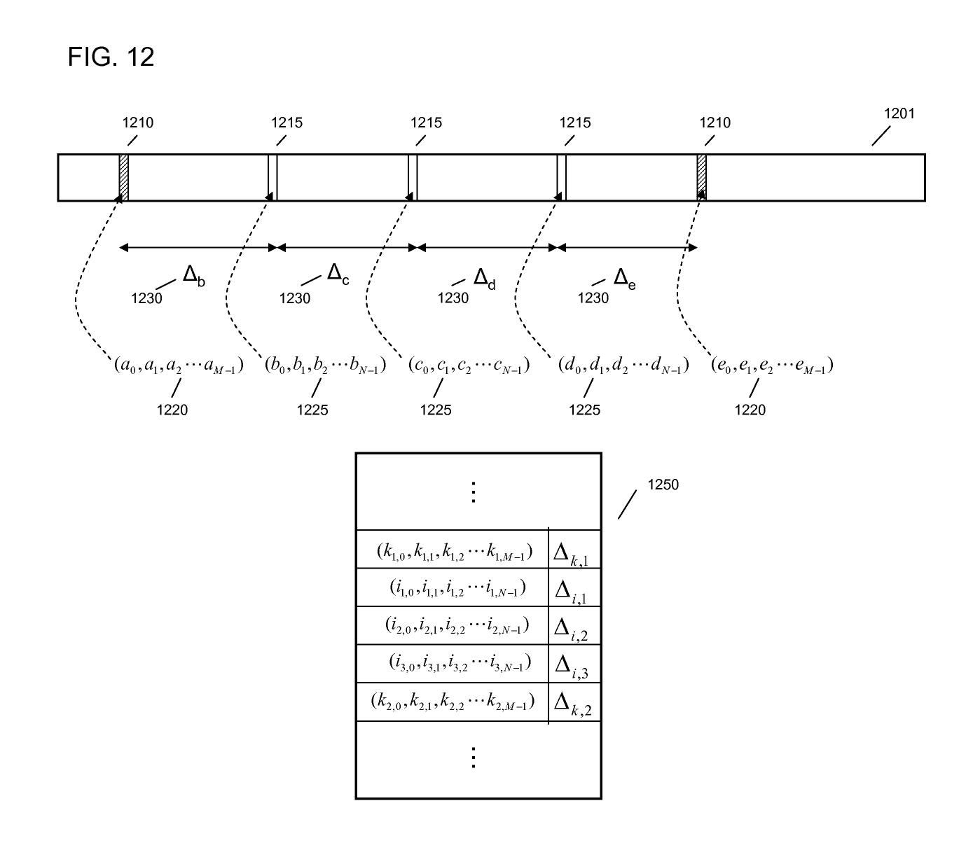

With reference to FIG. 12, a video sequence 1201 is illustrated from which key frames 1210 and intermediate frames 1215 have been identified. A frame characterization algorithm has been used to generate feature vectors 1220 for key frames 1210 and feature vectors 1225 for intermediate frames 1215. The frame characterization algorithm used to generate feature vectors for intermediate frames 1215 may or may not be the same algorithm that is used to generate feature vectors for the key frames 1210. In addition, the number of features generated from intermediate frames may be different, as indicated in FIG. 12 by the fact that the key frame feature vectors are denoted as having length M and the feature vectors for intermediate frames are of length N. (If similar algorithms are used M may equal N.) In addition, delta offsets 1230 giving the number of frames between adjacent selected frames are calculated. In FIG. 12 the offsets are shown as relative offsets though absolute offsets from a reference frame could also be used.

FIG. 12 also includes a reference vector index 1250. Reference vector index 1250 is an array that contains feature vectors for key frames and intermediate frames drawn from a video sequence. In addition it includes frame delta values identifying the number of frames between adjacent key and intermediate frame of the absolute distance of each key and intermediate frame from a fixed reference frame in the video sequence.

In one embodiment of the content overlay system, the frame characterization algorithm used to generate feature vectors for the frames calculates histograms for different regions and color planes of the image. In alternative embodiments, DCT or wavelet decomposition can be used to generate histograms or the centroid of the gradient of a color plane can be used. The color, spectral properties, centroid or other image featurs can also be used together to form feature vectors. The same algorithms may be used to calculate feature vectors for the intermediate frames.

Color histograms and DCT image decomposition are often used to derive feature vectors based exclusively on analysis of a single frame image. An alternative technique characterizes an entire sequence of video frames. For each frame in the range between any key frame and an intermediate frame and ending at the intermediate frame or for each frame between two intermediate frames, a region-by-region divergence measure based on comparing the feature vectors of the current frame to the previous frame. This method would involve generating sums of the form:

$${\sum }_{l ∈ L} {( {F}_{l , Y} ( {z}_{1} ) - {F}_{l + 1 , Y} ( {z}_{1} ) )}^{2} + {( {F}_{l , U} ( {z}_{1} ) - {F}_{l + 1 , U} ( {z}_{1} ) )}^{2} + {( {F}_{l , V} ( {z}_{1} ) - {F}_{l + 1 , V} ( {z}_{1} ) )}^{2}$$

$${\sum }_{l ∈ L} {( {F}_{l , Y} ( {z}_{2} ) - {F}_{l + 1 , Y} ( {z}_{2} ) )}^{2} + {( {F}_{l , U} ( {z}_{2} ) - {F}_{l + 1 , U} ( {z}_{2} ) )}^{2} + {( {F}_{l , V} ( {z}_{2} ) - {F}_{l + 1 , V} ( {z}_{2} ) )}^{2}$$

$$…$$

$${\sum }_{l ∈ L} {( {F}_{l , Y} ( {z}_{R} ) - {F}_{l + 1 , Y} ( {z}_{R} ) )}^{2} + {( {F}_{l , U} ( {z}_{R} ) - {F}_{l + 1 , U} ( {z}_{R} ) )}^{2} + {( {F}_{l , V} ( {z}_{R} ) - {F}_{l + 1 , V} ( {z}_{R} ) )}^{2}$$

where Fₗ, Fₗ₊₁ are feature vectors for adjacent frames, l ranges across all of the frames in window L, where L is the set of frames starting with one comparison frame and ending at the frame that precedes the next comparison frame, subscripts Y, U and V indicate color planes and z₁, z₂ . . . z_{R} denote R different regions in the frame. The divergence values are accumulated from the previous key frame or intermediate frame. At each of the following intermediate frames, the accumulated divergence values for each region and/or color plane are compared and an ordinal ranking of the accumulated divergence values is produced. This ordinal ranking could serve as a feature metric that can be included in the feature vector for the intermediate frame that concludes the video sequence. This method has the advantage that the ordinal rankings at the intermediate frames would be based on all of the activity in the video between the key frame and the intermediate frame and would not be derived exclusively from the single image in the intermediate frame. Using an ordinal ranking of image regions based on their comparative divergence rather than the actual calculated divergence produces a video signature that is less sensitive to variations in frame rates, contrast and illumination or other variations in image quality introduced by different encoding techniques. The use of ordinal rankings in video comparison is described in Chen & Stentiford, “Video Sequence Matching based on Temporal Ordinal Measurement,” Pattern Recognition Letters, vol. 29, no. 13 (October 2008).

In one embodiment of the invention, the content overlay system compares a video program to a reference sequence of key frames and intermediate frames by identifying a sequence of key frames and, possibly, intermediate frames by:

i) identifying a sequence of key frames and intermediate frames from the program being viewed using a comparison frame identification algorithm;

ii) comparing the key frames in the source to the key frames in the reference based on the similarity (absence of divergence) of their feature vectors and the similarity of the frame delta (or frame count normalized based on frame rate) between the identified key frames; and

iii) comparing the intermediate frames based on the similarity of the feature vectors.

With reference to FIG. 12, the first step above (i) is performed by identifying key frames 1210 and intermediate frames 1215. The second step (ii) is performed by generating feature vectors 1220 for key frames 1210 and feature vectors 1225 for intermediate frames 1215. These are then compared to the feature vectors for key frames and intermediate frames contained in reference vector index 1250. To carry out this comparison one of the available measures of divergence is used to determine the divergence between the corresponding feature vectors. In the example shown in FIG. 12, program feature vector (a₀, a₁, a₂ . . . a_{M-1}) could be compared with reference feature vector (k_{1,0},k_{1,1},k_{1,2} . . . k_{1,M-1}) , program feature vector (b₀,b₁,b₂ . . . b_{N-1}) could be compared with (i_{1,0}, i_{1,1}, i_{1,2} . . . i_{1,N-1}), etc. In addition the spacings between the compared frames would be compared. Δ_{b} could be compared to Δ_{i,1}, Δ_{c} could be compared to Δ_{i,2}, etc. A particularly significant distance metric is the comparison of the distance between key frames 1210 (i.e. the comparison of Δ_{b}+Δ_{c}+Δ_{d}+Δₑ with Δ_{i,1}+Δ_{i,2}+Δ_{i,3}+Δ_{k,2}). If the reference vectors in reference vector index 1250 were generated from the same section of video program that generated the feature vectors 1220 and 1225 and were calculated using the same comparison frame selection algorithm and the same frame characterization algorithms, there should be high degree of correspondence between the feature vectors and frame deltas. Note that in comparing frame offsets care must be taken to account for frame rate variations. Frame offsets should be normalized or scaled to a standard frame rate or measured in terms of units of time rather than absolute frame counts.

The first step (step (i) above) of identifying a sequence of key frames and intermediate frames must necessarily take place at the set-top box 600. The second and third comparison steps (steps (ii) and (iii) above), however, involve comparison of some part of the frame sequence from the viewed program to a reference. That can occur at a server where feature vector references for a variety of programs are kept. Once the program has been identified and the reference vectors retrieved by set-top box 600, ongoing comparisons between the reference vectors and the continuing set of key frames and intermediate frames generated as the program is played back can be done at the set-top box 600.

The algorithms for identifying key frames and for generating feature vector values must be relatively insensitive to differences that may arise between various recorded copies of television programming. These differences include the introduction of noise, contrast adjustments, aspect ratio adjustments (“letterboxing”), frame rate differences and the like. Some of these, such as contrast and aspect ratio adjustments can be addressed in part by preprocessing of the video frames before the image matching algorithm is applied, and selection of the image regions that are to be compared. In one embodiment of the invention, the overlay content system may generate reference vector arrays for different resolutions, frame rates and/or aspect ratios of the program.

With reference to FIG. 6, the process of generating key frame metrics can be performed on programming that originates in tuner/DVR 610 as well as programming that originates from other devices but is supplied to I/O interface 670.

A video program may be generated by the tuner/DVR 610 if the users are watching the program “live” or it may be decoded by codec 630s if the program has been recorded or is received by tuner/DVR 610 in an encoded format. Depending upon the particular encoding/decoding scheme used it may be convenient to have codecs 630 generate feature vectors for the video frames as they are decoded and supply these to video controller 640, which can then identify the key frames. Alternatively, video controller 640 can calculate feature vectors for video frames after they have been placed in frame memory 660 by tuner/DVR 610 or codecs 630.

Once key frames have been identified by the video controller 640 the feature vectors for these key frames can be stored in volatile memory 680 or, if the program itself is in long term storage in non-volatile storage 685, the calculated feature vectors for the selected key frames may also be stored there. The frame feature vectors can be generated any time video programming is retrieved by tuner/DVR 610 either for immediate presentation or for coding by codecs 630 and storage in non-volatile memory 685, or when it is retrieved from non-volatile memory 685 for decoding by codecs 630 and presentation through frame memory 660 and I/O interface 670. Alternatively, if the video program has been stored in non-volatile storage 685, the feature vectors for the video program can be generated by video controller 640 at any convenient time after the program has been stored and before it is viewed.

The overlay content system can also be used with video programming originating outside of set-top box 600 provided that the video stream is supplied to I/O interface 670. In this configuration, I/O interface 670 loads frames from the externally generated video into frame memory 600. Video controller 640 then generates feature vectors for the frames as it might with any source.

### Program Matching

Once the set-top box 600 has identified feature vectors for a set of key frames, they can be used to assist in identifying the video program from which they were calculated.

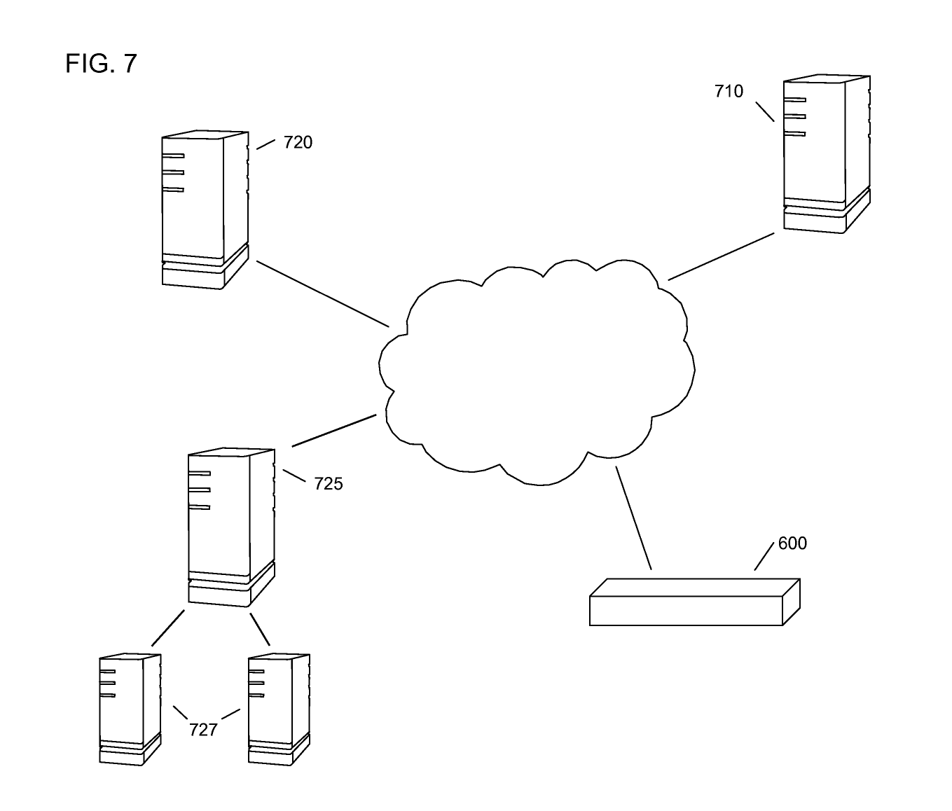

FIG. 7 illustrates an overlay content system that includes a set-top box 600 that provides overlay content service to an end-user, a tracking server 710 that provides reference vector indexes like reference vector index 1250 from FIG. 12, for many programs and an overlay content server 720 that provides overlay content related to the reference vector index data provided by the tracking server 710. The reference vector index data identifies reference frames in the underlying program. Particular passages from the program can be identified by starting and stopping points related to the reference frames in the reference frame index. An overlay content source, such as content server 720, can used these references to identify what parts of the program particular overlay content is relevant to, or, in the case of synchronous content, what parts of the program the content is to be synchronized with. While tracking server 710 and content server 720 are shown resident on separate host computers in FIG. 7, the same host computer may perform both functions.

In addition, FIG. 7 includes an aggregating server 725 that supplies reference vector index data and coordinated overlay content that is hosted on other servers 727. The use of an aggregating server 725 simplifies the search function performed by set-top box 600 as it allows the set-top box to access video tracking data and overlay content that originates from multiple sources 727 as the result of a query to a single aggregating server 725.

### Comparison Frame Index

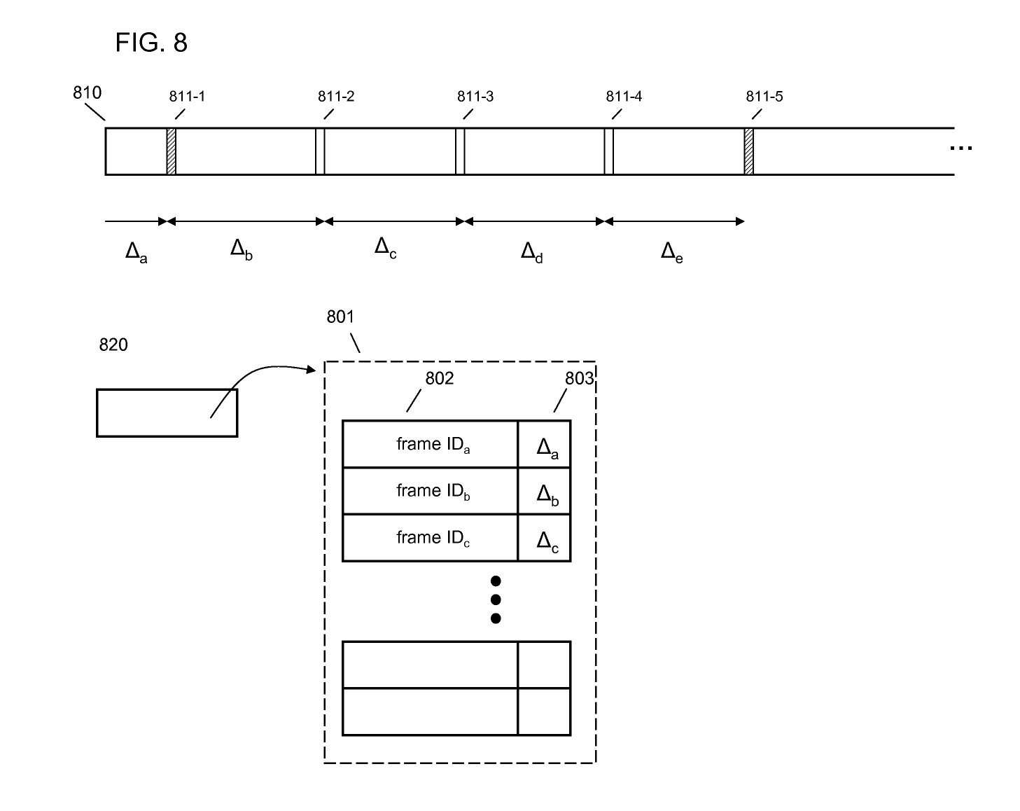

Tracking server 710 maintains a collection of reference vector indexes for various programs. The format of a reference vector index in accordance with one embodiment of the invention is illustrated in FIG. 8. The primary program that the content overlay system users are viewing is represented in video frame block 810 at the top of FIG. 8. Video frame block 810 is composed of a series of video frames that, in sequence, make up the program being viewed. Frame characterization algorithms and comparison frame selection algorithms have been used to identify key frames and intermediate frames, which we shall refer to inclusively as “comparison frames” 811. These are highlighted in FIG. 8.

The comparison frame index 801 is composed of a list of all of the comparison frames from the program. In the embodiment of the comparison frame index 801 shown in FIG. 8, each entry in the index includes at least two fields. The first field is the frame identifier (frame ID) 802 for the comparison frame. In one embodiment of the invention the frame ID 802 is the feature vector generated by the frame characterization algorithm. In another embodiment, the feature vector used to select key frames may include a different collection of frame features/metrics than the feature vector that is included in frame ID 802 in comparison frame index 801. In yet another embodiment, the frame ID 802 may not correspond to a feature vector directly but may be derived from feature vectors by a process in which the precision of the feature vector is reduced by combining and condensing the data of the vector into fewer bits. If the frame ID 802 is a condensed representation it should have the property that that two frame measurement results that were similar to each other before being condensed should be identical or similar after being condensed. It is also desirable if frame ID 802 is produced in a way that ensures that the values of the frame IDs of multiple frames corresponding to random images should be distributed randomly across the available range of frame ID values. This ensures that the bits that are allocated for use with frame ID 802 are used efficiently and that frame ID 802 has the greatest possible resolving power in distinguishing one frame of a video program from a different frame.

The second field in the entries in comparison frame index 801 is an offset value 803 that identifies the location of the key frame to which this entry corresponds. This offset can be an absolute offset that identifies the number of frames between the beginning of the program or some other fixed reference point such as an identified key frame, and the comparison frame to which this video track entry corresponds. Alternatively the offset 803 can be relative to the prior comparison frame. In FIG. 8 the offsets are depicted as relative offsets.

Each comparison frame index 801 is identified by a unique frame index identifier 820 that can serve as a shorthand reference to the comparison frame index 801.

Returning to FIG. 7, in order to identify a program, set-top box 600 first queries one or more tracking servers 710 to determine if they have a comparison frame index for a program. If the set-top box 600 has access to the bibliographic information about the program commonly found in an EPG (e.g. the title, the originating network, broadcast time, etc.), this information can be used to identify the program in the query. Alternatively, or in addition to the EPG information on the program, the set-top box 600 may also transmit a set of feature vectors and offsets that set-top box 600 has calculated from a set of comparison frames drawn from some part of the program. The tracking server 710 looks for matches where both the feature vectors and offsets between identified comparison frames of the frame sequence supplied by set-top box 600 match up with comparison frames in one of the comparison frame indexes 801 stored on the server. In doing so it can use any program bibliographical information provided by the set-top box 600 to narrow the search. If a match is found, the tracking server may conclude that the program on set-top box 600 is the same as the video program that generated the comparison frame index 801 stored on the server.

If the tracking server 710 matches the bibliographic information for the program and/or the comparison frame sequences supplied by the set-top box 600 with a comparison frame index 801, the tracking server 710 can make comparison frame index tracks available to set-top box 600 for transfer. Set-top box 600 can use the comparison frame index 801 to track playback progress through the video and, as described below, to associate overlay content with specific parts of the video program.

Typically the tracking server 710 would be accessed by the set-top box 600 through the internet, but in one embodiment a tracking server could be implemented directly in the set-top box 600. This tracking server would retrieve comparison frame indexes 801 from other network devices, allowing the identification of programs known to be of interest to users of the set-top box, perhaps because of the user's past viewing habits, or because they had configured “season” recordings of these programs. If content could not be identified by this internal tracking server, the set-top box would then turn to other external tracking servers 710 to identify content.

### Obtaining Overlay Content

Returning to FIG. 7, once the set-top box 600 has obtained one or more comparison frame indexes 801 from one or more tracking servers 710, it may obtain overlay content references identifying overlay content that is available for the program. The set-top box 600 may query content server 720 to determine what overlay content information it has relevant to the program of interest. In order to identify the program set-top box 600 may use the bibliographic data for the program, or it may use one or more frame index identifiers 820.

If content server 720 has overlay content relevant to the identified program or that is based upon one or more of the comparison frame indexes 801 identified by the set-top box 600, the content server 720 may make this overlay content available for transfer. In one embodiment of the invention, the content server offers an overlay content reference that identifies the content and can be used to retrieve the actual data for the overlay content, and summary information that provides a brief description of the overlay content. The set-top box 600 may download the overlay content reference and the summary information. These provide enough information to identify the overlay content to the user. If the user then elects to view this content, the set-top box 600 can then return to the content server 720 to retrieve the actual content.

### Asynchronous Overlay Content

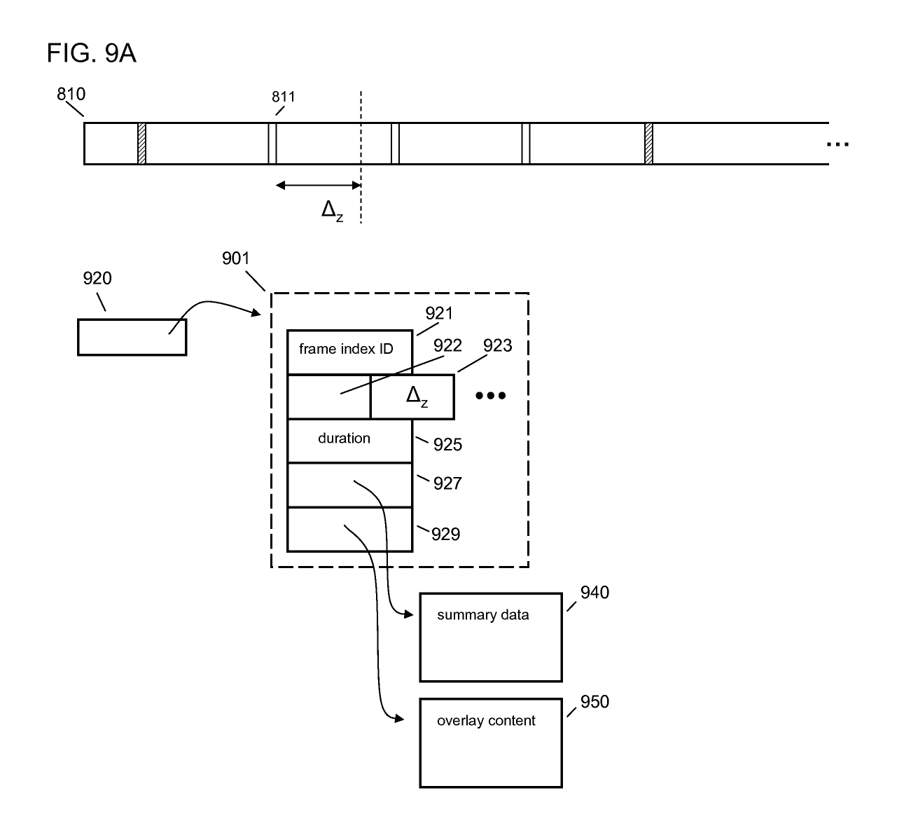

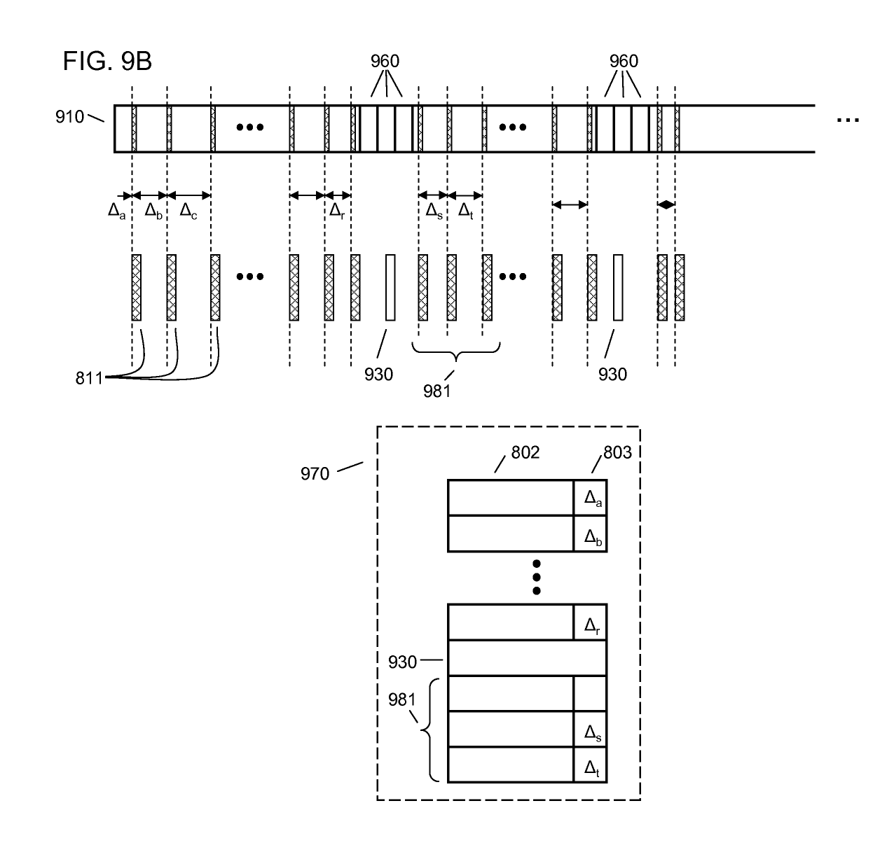

The format of an overlay content data structure for asynchronous overlay content in one embodiment of the invention is illustrated in FIG. 9A. Overlay content data structure 901 specifies what window of time (frames) the overlay content is relevant to during program playback. It also identifies the source for summary data 940 describing the content as well as the actual overlay content 950.

The first field in overlay content data structure 901 is the frame index identifier 921. This contains the frame index identifier value 820 for the comparison frame index 801 that the overlay content is referenced to. Fields 922 and 923 specify the starting location of the playback window within the program where the overlay content has relevance. Field 922 is a comparison frame index number identifying a particular comparison frame in the comparison frame index 801 identified by frame index identifier 921. Field 923 is an offset from that comparison frame specifying a particular frame in the program that marks the beginning of the playback window for this overlay content. In FIG. 9A, the offset is identified as Az from a comparison frame 811 specified by field 922. An overlay content data structure 901 may include multiple pairs of key frame indexes 922 and offsets 923, but each should specify the same starting frame for the playback window.

Duration field 925 identifies, in seconds or frames (at a normalized frame rate), the duration of the playback window for this overlay content reference. Field 927 is a reference to summary data 940. This can be a file descriptor, URL or other data sufficient to allow the set-top box 600 to retrieve summary data 940. The summary data includes the information necessary to make an initial description of the content to the overlay content system user. This would include, typically, an icon representing the overlay content that can be used to represent the content on a monitor 110 or wireless device 180 as illustrated in FIGS. 3A, 3B and 4. It may also include a brief text description, an identification of the format and nature of the content, such as whether the content is text, audio, video, etc. Overlay content reference 929 provides the information necessary to allow the set-top box 600 to retrieve overlay content 950.

With reference to FIGS. 6 and 7, the process of querying one or more tracking server(s) 710 for matching comparison frame indexes 801 and retrieving those indexes from the tracking server(s) 710 is done by system controller 620 communicating with tracking server(s) 710 through either one of wired network interface 691 or wireless network interface 692. The system controller may use comparison frames and frame ID values provided by codecs 630 or video controller 640 and program bibliographic data sourced from tuner/DVR 610. The task of retrieving frame indexes 801 from tracking server 710 and overlay content information such as overlay content data structure 901 from content server 720 is performed by system controller 620 communicating with the appropriate servers using either network interfaces 691 or 692.

### Tracking Playback Position and Identifying Relevant Content

Overlay content is coordinated with a comparison frame index 801. When the content is asynchronous the comparison frame index 801 serves to identify what parts of the program the overlay content has relevance to. When the content is synchronous with the program, the comparison frame index 801 is also used to ensure that the overlay content is played back synchronously with the program.

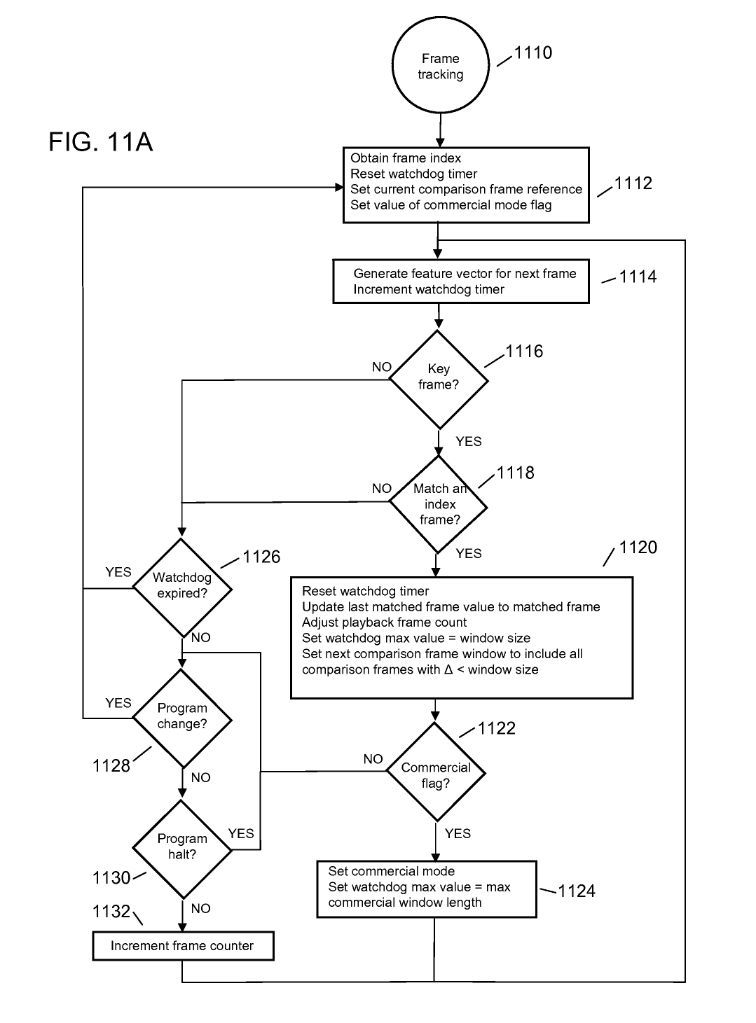

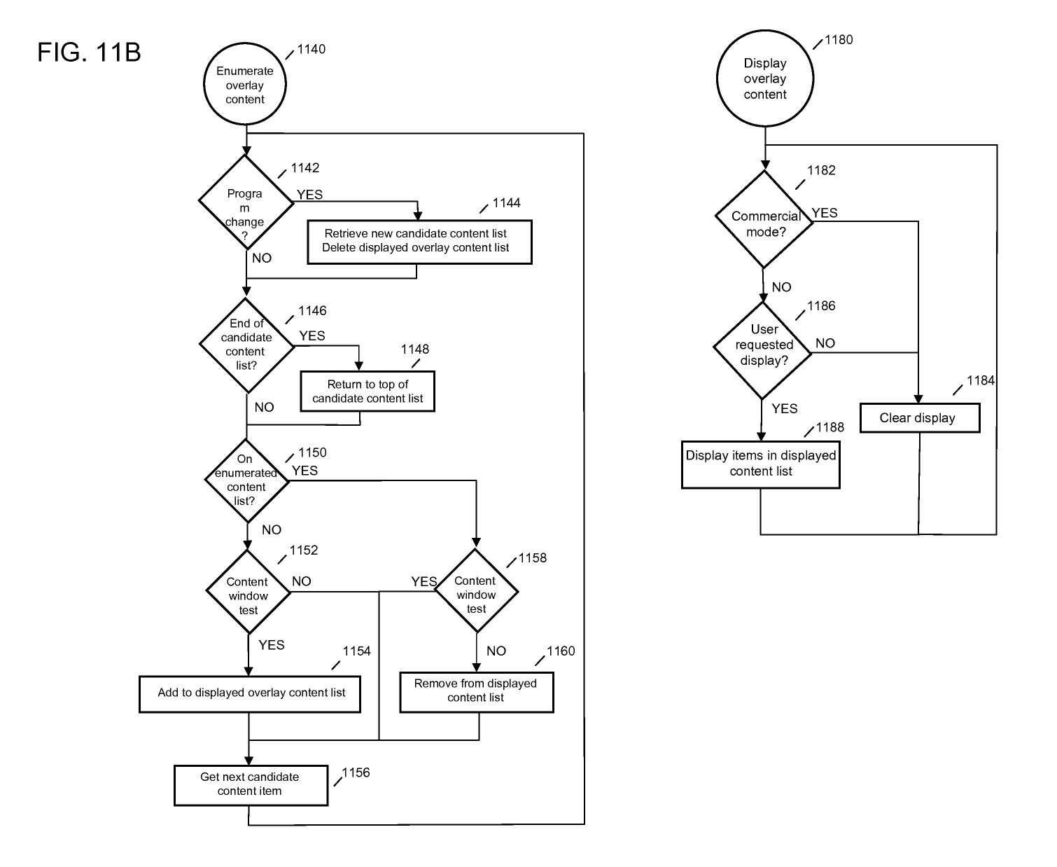

FIGS. 11A and 11B illustrate flowcharts of processes, according to one embodiment of the invention, for tracking the current playback state of a program against a comparison frame index 801, for determining what overlay content is relevant to the current playback state and for identifying that content to the user. The tracking algorithm 1110 shown in FIG. 11A produces at least three system state values: i) the last matched comparison frame, ii) the playback frame count and iii) the commercial mode flag. The last matched comparison frame value identifies the last frame from the comparison frame index 801 that was matched to content in the program. The frame count value identifies the current playback location in the program by frame number. The commercial mode flag is a boolean value that is set true when the program on the monitor 110 is in a commercial break.

With reference to the tracking algorithm 1110 in FIG. 11A, in step 1112 the tracking process retrieves a comparison frame index 801 for the current program from a tracking server 710. The tracking process tries to match a window of the last comparison frames identified by set-top box 600 from the program against comparison frames from the comparison frame index 801. This enables the tracking process to identify the last matched comparison frame whose frame ID 802 was matched to a frame in the program playing on set-top box 600 and monitor 110. The system also determines a current frame count value based on the offset values 803 from frame index 801 and the number of frames that have played since the last matched comparison frame was encountered. The commercial mode flag is set false if the current program is not in commercial. Finally in step 1112 the tracking process also resets the value of a watchdog timer that will be used to track the time (frames) since the last matched comparison frame identified by the set-top box 600 from the viewed program was matched to a comparison frame in the comparison frame index 801.

In step 1114, the tracking process applies the frame characterization algorithm to the next frame of the program to produce a feature vector for the frame. The watchdog timer values are decremented as another frame is played. The tracking algorithm then proceeds to step 1116. In step 1116, the tracking process applies the comparison frame selection algorithm to determine from the feature vector whether the current frame is a comparison frame, i.e. a key frame or intermediate frame. If it is a comparison frame, the tracking process proceeds to step 1118, otherwise it proceeds to step 1126. In step 1118, the tracking process determines a frame ID for the frame based on the calculated feature vector to determine whether the current frame matches one of the frame IDs in a “tracking window” of comparison frames that fall after the last matched comparison frame in the comparison frame index 801. The tracking algorithm 1110 does not look only at the comparison frame immediately after the last matched comparison frame but also considers subsequent frames from frame index 801 under the theory that one or more comparison frames might have been missed. In attempting to match the frame ID with a frame ID 802 in a comparison frame index 801, the tracking algorithm compares the value of the frame ID for the current playback frame against the frame IDs for all of the comparison frames in the tracking window, but also considers how closely the playback frame count matches the frame offset values 803 for the comparison frames in the tracking window. If the frame offset values 802 are absolute offsets they can be compared directly to the playback frame count. If the frame offset values 802 are relative offsets, they must be accumulated to be compared to the playback frame count.

The size of the tracking window may be configured to include a fixed number of comparison frames or it may include all comparison frames that fall within some specified period of time or number of frames forward from the last matched frame. If the frame ID of the current program frame and the playback frame count is a sufficiently close match to the frame ID 803 and frame offset 802 of one of the frames in the tracking window, the tracking process identifies this as a match and proceeds to step 1120. If a match is not made, the set-top box proceeds to step 1126.

In step 1120, the tracking process performs several steps. It resets the watchdog timer that counts the number of elapsed program frames since the last comparison frame match. It updates the last matched comparison frame reference to refer to the comparison frame in the frame index 801 that was matched to the current playback frame. If there is a discrepancy between the playback frame count and the frame offset 802 of the matched comparison frame, the playback frame count can be adjusted to reflect the frame offset 802 from the frame index 801. In step 1120, the tracking process also sets the expiration value of the watchdog timer to be equal to a standard number of frames. The watchdog timer duration defines the amount of time that can elapse between occasions where the frame IDs of frames from the program are successfully matched to frame IDs for comparison frames from the comparison frame index 801. If the watchdog timer runs out before a match is made the tracking process presumes that program tracking has been lost. Finally, the tracking process identifies the comparison frames from the comparison frame index 801 that fall within the new comparison frame index window based on the new position of the last matched comparison frame value.

In step 1122, the tracking process determines whether the entry in the comparison frame index file is a commercial flag. As described below in connection with FIG. 9B, a commercial flag is an entry in a comparison frame index that identifies a point in the program where commercials may be inserted. If the next entry is a commercial flag, the tracking process proceeds to step 1124. If it is not the process goes to step 1128.

In step 1126, the tracking process determines whether the watchdog timer has expired, indicating that too much time has elapsed since the last comparison frame from the program was matched to a frame ID in the comparison frame index 801. If the watchdog timer has expired, the tracking process goes to step 1112, where a new comparison frame index 801 is acquired or a new playback position in the current comparison frame index 801 is identified. If the watchdog timer has not expired, the tracking process proceeds to step 1128.

In step 1128, the tracking process determines whether the tuner/DVR function indicates that a program change has occurred. If a program change has occurred the set-top box proceeds to step 1112. If there has been no program change, the tracking process proceeds to step 1130. In step 1130, the tracking process determines from the tuner/DVR function whether there has been a halt in playback of the program. If a halt has occurred, the tracking function dwells at the current location by returning to step 1128. If a halt has not occurred the tracking process proceeds to step 1132. In step 1132 the playback frame count value is increments. The tracking process then advances to step 1114.

In step 1124, the tracking process changes the expiration value for the watchdog timer to a value appropriate to accommodate the duration of a standard series of commercials. This value will typically be substantially longer than the expiration value for the watchdog timer during searching for a matching comparison frame during normal tracking of program frames. The tracking process then proceeds to step 1114.

In overlay content systems that are not integrated with a tuner/DVR, step 1128 could be eliminated, since the system controller 620 would have no way of knowing whether a program change had occurred. Step 1130 could still be performed since the content overlay system can identify a program halt by the fact that the audio stops and the video remains fixed or goes dark.

FIG. 11B is a flowchart of the processes for displaying relevant overlay content. The content enumeration process 1140 builds a list of relevant content that is to be displayed when requested by the overlay content system user. The display process 1180 causes the available overlay content to be displayed when the user requests it.

The content enumeration process generates several data items: i) a candidate content list composed of the overlay content items associated with the program by frame index identifiers 921 that correspond to the comparison frame index identifiers 820 for the program, ii) a current candidate pointer that points to a particular piece of overlay content in the candidate content list, and iii) an enumerated overlay content list that includes of all of the overlay content that is relevant to the current playback position of the program.

In step 1142 the content enumeration process 1140 tests whether there has been a change in the program displayed on the monitor 110. If there has been a program change the content relevance process 1140 proceeds to step 1144, otherwise to step 1146. In step 1144 the current list of enumerated content is emptied and a new list of candidate overlay content relevant to the new program is retrieved by the overlay content system, as discussed earlier in connection with FIG. 7. The content enumeration process sets the value of a current candidate pointer to point to the top entry in this new candidate content list. The content relevance process 1140 then proceeds to step 1146.

In step 1146, the content enumeration process 1140 determines whether the current candidate pointer points to a valid entry in the list of candidate content list or if the end of the list has been reached. If the current candidate pointer refers to a valid overlay content candidate, the process proceeds to step 1150, otherwise the process goes to step 1148. In step 1148 the current candidate pointer is reset to point to the first entry in the candidate content list. The process then proceeds to step 1150.

In step 1150, the content enumeration process determines whether the overlay content identified by the current candidate pointer is currently in the enumerated overlay content list. If it is the process proceeds to step 1158, otherwise to step 1152. In step 1152, the content enumeration process determines whether the frame count value generated by tracking process 1110 indicates a frame that falls in the “play window” for the overlay content. The play window starts at the frame defined by key frame index 922 and offset 923 from the overlay data structure 901. The length of the play window for the overlay content is defined by duration field 925. If the current playback frame does fall in the play window of the candidate overlay content, the content enumeration process proceeds to step 1154, otherwise to step 1156.

Step 1158 performs the same test described in step 1152, but this time if the current playback frame falls in the play window of the candidate overlay content the process proceeds to step 1156, otherwise to step 1160.

In step 1154 the content enumeration process 1140 adds the candidate overlay content identified by the current candidate parameter to the list of enumerated overlay content. The process then proceeds to step 1156. In step 1160 the candidate overlay content identified by the current candidate pointer is removed from the displayed overlay content list. The process then proceeds to step 1156.

In step 1156 the content relevance process 1140 advances the current candidate pointer to point to the next entry in the list of candidate overlay content and proceeds to step 1142.

The algorithm shown in FIG. 11B determines which overlay content should be included in the enumerated content list by repeatedly cycling through all of the available content to check whether the current playback position is outside the play window for that content. This implementation is simple in design but not particularly efficient. An alternative design for the algorithm would sort the members of the candidate content list by the starting frame of their play windows and would sort the members of the enumerated content list by the ending frame of their play windows. This way, assuming that the playback frame advanced steadily forward, the algorithm would need only to check whether the starting frame of the play window for the next item in the candidate content list had been reached and whether the ending frame for the next item in the displayed content list had been passed. If the playback position was abruptly changed due to a rewind or fast forward or the like, a more general search through the lists would have to be made.

The content display process 1180 shown in FIG. 11B causes the contents of the enumerated overlay content list to be identified visually to the user, upon request.

In step 1182 the content display process determines if the commercial mode flag generated by the frame tracking process 1110 in FIG. 11A has been set. If it has, the content display process proceeds to step 1184, otherwise to step 1186. In step 1184 any existing display of available relevant overlay content is withdrawn from monitor 110 or associated display devices such as wireless device 180 and the process proceeds to step 1182.

In step 1186 the content display process tests whether the user has requested that the available relevant overlay content be identified. If the user has requested that overlay content be identified the process proceeds to step 1188, otherwise to step 1184. In step 1188 the content included in the enumerated content list generated by the enumerated content process 1140 is identified to the viewer either on monitor 110 or associated wireless devices 180. The process then proceeds to step 1182.

With reference to FIG. 6, in one embodiment of the present invention the tracking algorithm 1110 shown in FIG. 11A is implemented by system controller 620 based on comparison of feature vectors derived from key frames and intermediate frames calculated by video controller 640. The enumerated overlay content algorithm 1140 is also implemented by system controller 620. If the overlay content identifiers are to be displayed on monitor 110, the generation and display of the available overlay content identifier graphics is done by video controller 640 based on summary data 940, shown in FIG. 9. The video controller 640 writes the relevant information to frame memory 660 where it becomes part of the video data transmitted to monitor 110 over I/O interface 670. If overlay content is to be displayed on wireless device 180, the overlay content identifiers are generated on the wireless device based on summary data 940 which is supplied to the wireless device 180 by system controller 620 through wireless interface 692 or through wired interface 691 and wireless radio 175. Synchronous content

Synchronous content requires tighter coordination with the primary program. Unless the synchronous content is extremely short, typically synchronous content is divided into multiple discrete elements, each of which is separately coordinated with the key frame track 800 for the program.

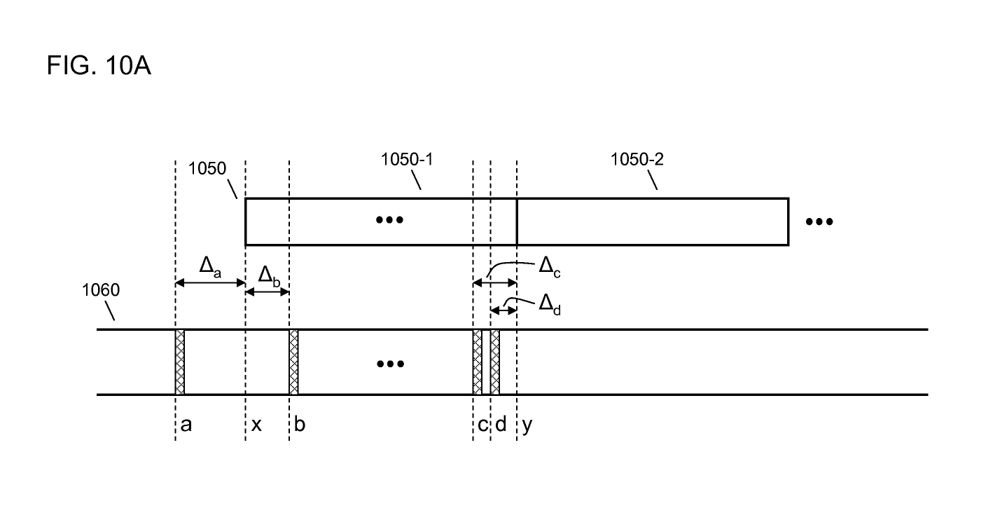

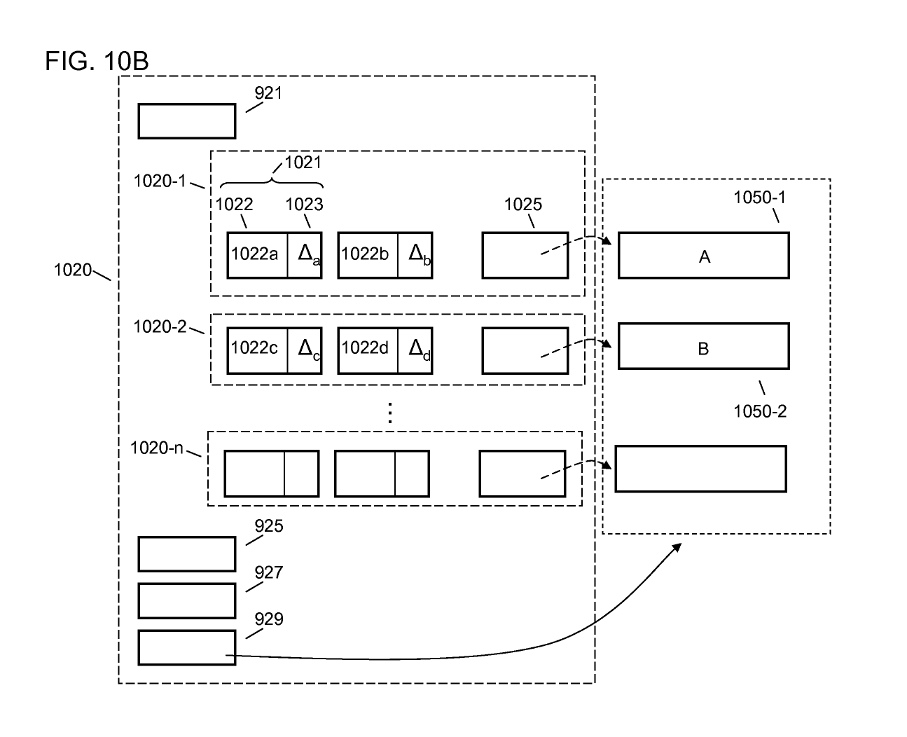

FIGS. 10A and 10B illustrate the data structures used in one embodiment of the invention for coordinating synchronous content with the comparison frames in a program. In FIG. 10A the underlying program 1060 is depicted running across time on a horizontal axis. Individual comparison frames a, b, c and d are highlighted. The synchronous overlay content 1050 is depicted above program 1060. The synchronous overlay content 1050 is broken into multiple individual segments 1050-1, 1050-2, etc. Synchronous overlay content may include many such segments. The first segment 1050-1 is to commence at frame x in the program, which is offset from key frames a and b by Δₐ and −Δ_{b} frames (at a normalized frame rate). The second segment 1050-2 is to commence at frame y, which is offset from comparison frames c and d by Δ_{c} and Δ_{d} frames.

As illustrated in FIG. 10B, the overlay content package 1020 for synchronous program 1050 is organized into discrete segments 1020-1, 1020-2 . . . 1020-n. Each segment includes one or more starting references 1021, each of which includes a comparison frame identifier 1022 that identifies a comparison frame in the comparison frame index 801 and an offset 1023 that identifies the offset between the comparison frame and the starting frame for the synchronous program. Finally each segment of the overlay content package 1020 also includes a reference 1025 that relates the segment to one of the segments 1050-1, 1050-2, . . . 1050-n of the synchronous content.

The overlay content package 120 for synchronous content also includes frame index identifier 921, duration field 925, summary data reference 927 and overlay content reference 929. These data items have the same function for synchronous data as they do in the overlay content data structure 901 shown in FIG. 9A.

### Playing Overlay Content

With reference to FIGS. 1, 6, 9A and 10B, when the user selects overlay content to play it, the system controller 620 determines whether the content can be played on monitor 110, audio system 120 and/or wireless device 180. Some content synchronized to the video program, such as the overlay content illustrated in FIG. 5, can only meaningfully be displayed on the monitor with the primary video programming. Other content, such as the separate video and audio streams discussed in connection with FIG. 4, can be played either on monitor 110 and audio system 120 or on an associated device such as wireless device 180.

The suitability of the overlay content for playback on various types of displays and devices is identified in summary data 940. The system controller 620 reviews summary data 940 to determine possible display options. These are then identified to the user either on monitor 110 or wireless device 180, as illustrated in FIG. 3C, and the user selects one of the available options.

If the overlay content is video or graphics to be displayed on monitor 110, the system controller 620 uses overlay content reference 929 to retrieve overlay content 950 or 1050 using one of network interfaces 691 or 692. Depending on its size, the overlay content 950 may be transferred from content servers in one transfer or may be streamed in multiple separate transfers. The content can be stored in volatile memory 680 or non-volatile storage 685. If the overlay content is encoded video, with or without concurrent audio, the system controller 620 directs codecs 630 to decode the video and any audio and write the results to frame memory 660. From there it is transferred through I/O interface to monitor 110.

If the overlay content is encoded audio it can be decoded using codecs 630, stored in frame memory 660 and output to monitor 110 and/or amplifier 120.

If the overlay content 950 or 1050 is a body of instructions for VM 650 or other data in a format, such as Flash, suitable for execution on a player implemented on VM 650, the system controller 620 retrieves the overlay content using wired or wireless network interfaces 691 and 692 and stores it in volatile memory 680 or non-volatile storage 685. System controller 620 determines what player applications are necessary to display the specific type of overlay content requested by the user, to retrieve the player applications from non-volatile storage 684 and to launch them on VM 650. The resulting graphics, video or audio are written to frame memory 660 for overlay over the primary program and subsequent transfer through the I/O interface 670 to the monitor 110.

If the user requests that overlay content be played on a wireless device 180, system controller 620 transfers overlay content data structure 901 to wireless device 180 using wireless network interface 692 or wired network interface 691 and wireless radio 175. The overlay content system application on wireless device 180 retrieves the overlay content 950 identified by overlay content reference 929. The wireless device 180 then uses whatever internal codecs or player software is required to convert the overlay content 950 or 1050 into video, graphics or audio for presentation to the user. If the overlay content presented on wireless device 180 is synchronous with the video program played on monitor 110, the system controller 620 monitors the playback progress of the video program through the various frames that correspond to the starting points for playbakc of the various discrete segments 1020-1, 1020-2 . . . 1020-n of the synchronous content and informs the the wireless device 180 when a new segment of synchronous content should be played.

If synchronous overlay content is played on monitor 110, system controller 620 ensures that the content remains synchronized to the playback of the program. The system controller 620 tracks the current playback position. System controller 620 directs codecs 630 and/or VM 650 to generate video frames and audio as described in content segments 1050-1, 1050-2, etc. and to copy the resulting video and audio to frame buffer 650 when the current playback position reaches the frame identified by starting references 1021.

In an alternative embodiment, codecs 630 and VM 650 can generate video and audio content as described in overlay content sgements 1050-1, 1050-2, etc. and save the resulting video and audio to volatile memory 680. The video controller 640 is then charged with retrieving the video and audio segments from volatile memory 680 and playing them into frame memory 660 in synchronization with the playback frames of the video program as indicated by starting references 1021 for each segment of overlay content.

### Commercial Interruptions

When the primary program viewed on monitor 110 is broadcast television programming, the content overlay system has to deal with commercials that are inserted at regular intervals into the program. Commercials present a problem because different sets of commercials may be inserted into the program in different regions and a program may be broadcast multiple times with different sets of commercials, and with commercial breaks of different lengths. To address these issues, in one embodiment of the invention the comparison frame index 801 provided from a tracking server 710 may include data structures to identify the location of commercial interruptions and to allow them to be handled differently from other parts of the broadcast programming.

FIG. 9B illustrates how a comparison frame index 970 may be modified in one embodiment of the invention to accommodate commercial interruptions. The underlying video program 910 is represented horizontally at the top of the figure. Comparison frames 811 in the program are highlighted. The delta frame measurements 925 between comparison frames are identified in the figure. The program is interrupted in several places by a series of commercials 960.

The beginning and ending of commercials can ordinarily be detected by means well known to persons of ordinary skill in the art. Programming and commercials are normally separated by a fade to black and an audio fade to silence. The video controller 640 or codecs 630, which are charged in various embodiments of the invention with identifying comparison frames in the program as it is played, can detect these transitions to commercials and identify them as potential boundaries that may mark the beginning of another segment of the program or a commercial. The comparison frame index on tracking server 710 can exclude any comparison frames from commercials, and replace these with a commercial flag 930 that identifies that commercials or other program interruptions may occur at this point.

When the system controller 620 encounters a commercial flag 930 in the comparison frame index while tracking the progress of a video program it will “dwell” on a window of the comparison frames 981 in comparison frame index 940 that fall after commercial flag 930, trying to match the frame IDs 802 of any one of the frames in window 981 with the frame IDs generated by video controller 640 or codecs 630 from the primary program 910. The group of comparison frames included in this window is selected to be large enough so that the total elapsed program time included in this window is larger that typical accidental overlaps of broadcast commercials into the next segment of the program. In practice this means that the delta frame measures (Δₛ and Δₜ in the example from FIG. 9B) for the key frames in this window should sum to a period of time greater than any expected overlap of commercials into programming. The size of the window can be configurable. In FIG. 9B, the window 981 is shown as encompassing only three comparison frames. A larger number may be employed; three are used here for ease of illustration. The system controller 620 keeps track of the amount of elapsed time from when the commercial flag was encountered. If the set-top box cannot match the program key frames to the comparison frame metrics 931 and the elapsed time exceeds a configurable maximum on the amount of time that can elapse between a commercial boundary and reacquisition of frame tracking, the system controller 620 determines that program tracking has been lost and begins a search for frame indexes corresponding to the program content being displayed on monitor 110. In addition, in systems where the overlay content system controller may not have any communication with a source device such as a DVR, system controller 620 may communicate with tracking server 710 to try to match newly played comparison frames with a comparison frame index other than that currently being used for tracking.

We will refer to the period of time between when the system controller 620 encounters a commercial flag 930 and when the first frame corresponding to one of the post-commercial key frames 931 is recognized in the playback video as a “commercial window.” In one embodiment of the overlay content system, the system controller 620 causes any overlay content identifiers or icons, such as those shown in FIGS. 3A and 4, to be withdrawn from display on monitor 110 during a commercial window. Synchronous overlay content is also removed during commercials. Whether asynchronous content is removed from display depends on configuration of the content overlay system.

In some embodiments a overlay content system user can configure the system to search for overlay content for commercial segments. The system would search for content on these just as it would with any other programming. They would be treated, in effect, as 30 second long programs placed in between segments of the other programming.

### Live Programming

In addition to being used with recorded or rebroadcast television programming, the overlay content system can also be used with live television broadcasts. With live TV programming or first broadcasts other members of the general public will not have had a chance to associate overlay content with the program in advance of playback on set-top box 600. (For prerecorded programs the originator of the program and the network broadcasting it can, of course, prepare and distribute overlay content in advance of the broadcast.) In one embodiment of the invention, however, the overlay content system can allow new overlay content to be introduced even as the program is being played back on monitor 110.

Referring to FIG. 7, when a set-top box 600 communicates with tracking server 710, the tracking server may indicate that a comparison frame index available for the program in playback on the set-top box is being dynamically extended at the time of the request. The set-top box 600 may request to subscribe to updates of the frame index. If the request is granted, the tracking server 710 will provide frequent periodic updates of additional comparison frame index entries 802 and 803, as illustrated in FIG. 8, which are to be appended to the portions of the comparison frame index previously transmitted. These updates continue until the comparison frame index is completed or set-top box 600 terminates its subscription request.

Content server 720 may also offer a dynamic overlay content service. If set-top box 600 requests to subscribe to this service and the request is granted tracking server can forward newly received overlay content data structures 901 as shown in FIG. 9. In one embodiment of the invention, the duration field 925 can be configured to indicate an amount of time that extends beyond the present length of the frame index associated with frame index identifier 921. Set-top box 600 can be configured to reject durations of this form to impose a maximum length on duration field 925 for any overlay content data structure. In addition, the generator of the overlay content may revise the duration field 925 downwards or extend it. If there is a change in overlay content data structure 901, the new data structure can be forwarded to set-top boxes 600 that have subscribed to dynamic updates of overlay content for a particular program.

Collectively the dynamically extended comparison frame indexes and dynamic overlay content service allow new overlay content to be associated with a program as it is first broadcast and to presented to program viewers.

Many modifications and variations of the overlay content system are possible. In view of the detailed description and drawings provided of the present invention, these modifications and variations will be apparent to those of ordinary skill in the art. These modifications and variations can be made without departing from the spirit and scope of the present invention.

what is claimed is:

1. A method for presenting overlay content to viewers of a video program, the method comprising:
deriving a vector of feature values from a frame of a video program displayed on a monitor;
obtaining a sequence of frame identifiers;
comparing a frame identifier value based on said vector of feature values to a frame identifier from said sequence of frame identifiers;
obtaining data relating a piece of content to an identified portion of said sequence of frame identifiers; and
identifying said content on a display when said comparing step indicates that said displayed video frame is within said identified portion of the sequence of frame identifiers.

2. The method of claim 1 wherein the method of presenting overlay content further comprises:
permitting viewers of said video program to select said identified content; and
presenting said selected overlay content.

3. The method of claim 2 wherein said step of identifying content on a display includes presenting summary information identifying the content on a display other than said monitor.

4. The method of claim 2 wherein said step of presenting content includes presenting video or graphical content on a display device other than said monitor.

5. The method of claim 1 wherein said step of identifying content on a display involves presenting summary information identifying the content on one portion of said monitor.

6. An overlay content device comprising:
a network interface that allows retrieval and transmission of data, including one or more frame indexes each of which is derived from feature vectors that characterize a set of frames from a video program;
a video controller that matches data derived from frames in a viewed video program to corresponding data in one of said frame indexes in order to determine a frame position in a video program;
an overlay engine that generates graphical images and/or text to be overlayed onto said frames in a video program based on said frame position; and
a video interface for transmitting a video stream incorporating said frames in a video program overlayed with said graphical images and text.

7. The overlay content device of claim 6 further comprising:
a control processor; and
a software application for a wireless device that can communicate with said control processor so that content available for overlay on said frames in a video program is identified on the wireless device and may be selected using the software application.

8. The overlay content device of claim 6 further comprising:
a virtual machine that can process a set of instructions obtained across said network interface and, based upon said instructions, produce graphical images for overlay onto said frames in a video program.

9. The overlay content device of claim 8 wherein said overlay content device further comprises:
an audio interface for transmitting an audio stream; and
wherein said virtual machine can generate audio data that is combined with the audio of said video program for transmission over said audio interface.

10. The overlay content device of claim 6 further comprising:
a control processor that retrieves over said network interface overlay content data objects that include data enabling retrieval of the source data for said graphical images or text and also incorporate data fields that identify during what portion of said video program said graphical images or text may be presented.

11. A method for presenting graphics, video, audio and other data supplementary to a video program in coordination with playback of the program on a monitor, comprising the steps of:
determining the identity of a video program playing on a monitor;
retrieving content related to the video program whose identity was determined from a computer network where the retrieved content includes data defining a window of frames within said video program; and
visually identifying said retrieved content in synchronization with the playback of the video program on the monitor.

12. The method of claim 11 further comprising the steps of:
extracting feature vectors from at least some frames of the video program;
comparing said feature vectors or data derived from said feature vectors with one or more sets of data derived from frames of a video program;

13. The method of claim 11 wherein the step of visually identifying said retrieved content is performed on a display device other than said monitor on which the video program is presented.

14. The method of claim 11 wherein the method further comprises the step of:
presenting graphical images, text or audio defined by said retrieved content on a display device.

15. The method of claim 11 wherein the step of visually identifying said retrieved data further includes visually identifying said retrieved content only when the portion of the video program presented to the viewer falls within said window of frames defined in said retrieved content.

15. The method of claim 14 wherein the step of presenting graphical images, text or audio further comprises querying a user as to whether the graphical images, text or audio should be presented on the monitor or on a display device other than the monitor.
